(19) United States
(12) Patent Application Publication
(10) Pub. No.: US 2024/0049747 A1
(43) Pub. Date: Feb. 15, 2024

(54) METHODS FOR BLENDING ANIMAL AND PLANT PROTEIN MIXTURES WITH IMPROVED FOOD FUNCTIONALITY

(71) Applicant: Ohio State Innovation Foundation, Columbus, OH (US)

(72) Inventors: V. M. BALASUBRAMANIAM, Dublin, OH (US); Jerish Joyner JANAHAR, Columbus, OH (US); Rafael JIMENEZ-FLORES, Columbus, OH (US)

(21) Appl. No.: 18/268,072

(22) PCT Filed: Sep. 16, 2021
(86) PCT No.: PCT/US2021/050719

§ 371 Date: Jun. 16, 2023

Related U.S. Application Data
(60) Provisional application No. 63/126,890, filed on Dec. 17, 2020.

(51) Int. Cl. A23J 3/22; A23J 3/04; A23J 3/14

(52) U.S. Cl. CPC A23J 3/22; A23J 3/04; A23J 3/14

(57) ABSTRACT

Disclosed herein are methods of making and using, as well as products obtained by, continuous high pressure based Ultra Shear Technology (UST). These products are homogenous and stable blends of plant and animal proteins. These methods allow for the formulation and manufacture of stable liquid food products without the use of synthetic additives. The plant/animal protein blends are useful in formulating novel protein liquid foods with varied consumer applications.

### CROSS-REFERENCE TO RELATED APPLICATIONS

This application claims benefit of U.S. Provisional Application No. 63/126,890, filed Dec. 17, 2020, incorporated herein by reference in its entirety.

### GOVERNMENT SUPPORT CLAUSE

This invention was made with government support under 2018-67017-27914 awarded by the USDA, National Institute of Food and Agriculture. The government has certain rights in the invention.

### BACKGROUND

These days, food is intended not only to satisfy hunger but also to supplement nutrients required for health. Increasing consumer awareness on health promoting foods and demand for nutritional protein-based diets has led food industry to develop cost effective as well as sustainable protein foods. In the past decade, newer products such as plant protein based milk enabling balanced nutrition at low cost have found their way into the diets of many consumers. Several dairy milk substitute products based on oat, almond, soy, coconut, pea, and others. are on the market (Sethi et al., 2016; McClements et al., 2019). Plant based milk sales in the U.S. increased by 61% between 2012 and 2018 whereas sales of dairy milk category has declined by 15% since 2012 (Devenyns, 2019). However, there is limitation in acceptance by several consumers due to the beany, nutty flavors and bitter taste in some plant based liquid foods and inability to create the flavors of dairy milk, especially when used as coffee, tea or cooking ingredient (McClements et al., 2019).

‘Flexitarians’ who often move between plant and dairy based foods tend to prefer a more “natural” taste. Incidentally, about 33% of plant based milk consumers in US move back to dairy milk due to compromise in taste (NotCo, 2019). Further, while plant sources could provide good quantity of protein, the quality of dairy based milk protein is unmatched. Therefore, blending the plant and animal protein and creation of a ‘hybrid product’ is needed in the art. The synergistic action between proteins from different sources can lead to development of desirable textural and functional properties in the food.

Milk is an ideal dairy based protein source with whey and casein having unparalleled amino acids package. Pea protein is a plant protein with increasing attention owing to its nutrition content, lower price and sustainability (Lan et al., 2019). However, pea proteins possess low solubility and settle down as sediments during processing and storage, leading to non-uniformity in protein distribution in protein enriched beverages and milk substitutes. The poor functional performance of pea proteins such as emulsion stability and gelation property can lead to sedimentation of pea proteins, which can pose a challenge to its inclusion in liquid foods (Choi & Han, 2001; Nosworthy et al., 2017). Nichols and Cheryan (1982) observed that the functionality of relatively poor functional proteins can be improved by blending with dairy proteins.

The high pressure based novel ultra shear technology (UST) presents a promising way to blend proteins from plant and dairy sources through combined application of high pressure, shear and thermal exposure. In UST processing, the liquid blend is pressurized up to 400 MPa and passed through a tiny nozzle which exerts enormous shear and concomitant momentary temperature rise on the product. The treatment induces structural changes on fat globules and casein micelles in milk and promotes stability by preventing creaming (Janahar et al., 2021). Suitable blending of animal and plant proteins can provide a balanced nutrition at a reduced cost. Further, synergistic action between proteins from different sources can lead to the development of desirable textural and functional properties. Current protein blending methods are often ineffective because of sedimentation and lump formation during blending.

Furthermore, there is increasing consumer awareness on health-promoting foods, which has created a demand for novel foods containing nutritious proteins and fats from different diverse sources. The subject matter disclosed herein addresses these and other needs.

### SUMMARY

Disclosed herein is a method of using ultra sheer technology to form a homogenous product from a combination of a plant protein and an animal protein source, the method comprising: combining a plant protein source and an animal protein source; placing the plant protein source and animal protein source under conditions to form a homogenous product, wherein said conditions comprise pressure varying from 2,000 psi to 87,000 psi; and temperature from 5-100° C.; wherein shear enables blending of the animal and plant protein sources to form a homogeneous product.

Further disclosed herein is a method of using ultra sheer technology to form a homogenous product from a combination of an animal protein and an animal fat source, the method comprising: combining an animal protein source and an animal fat source; placing the animal protein source and an animal fat source under conditions to form a homogenous product, wherein said conditions comprise pressure varying from 2,000 psi to 87,000 psi; and temperature from 5-100° C.; wherein shear enables blending of the protein and fat sources to form a homogeneous product. In these methods, much like those described herein for a combination of plant protein and animal protein, different proportions of animal protein source and an animal fat source can be used. Example 2 provides an example of how this can be accomplished.

Also disclosed herein is a product made by the process of using ultra sheer technology to form a homogenous product from a combination of a plant protein and an animal protein source, the method comprising: combining a plant protein source and an animal protein source; placing the plant protein source and animal protein source under conditions to form a homogenous product, wherein said conditions comprise pressure varying from 2,000 psi to 87,000 psi; and temperature from 5-100° C.; wherein shear enables blending of the animal and plant protein sources to form a homogeneous product.

Further disclosed herein is a product made by the process of using ultra sheer technology to form a homogenous product from a combination of an animal fat and an animal protein source, the method comprising: combining an animal protein source and an animal fat source; placing the animal protein source and animal fat source under conditions to form a homogenous product, wherein said conditions comprise pressure varying from 2,000 psi to 87,000 psi; and temperature from 5-100° C.; wherein shear enables blending of the animal protein and fat sources to form a homogeneous product.

Additional advantages of the disclosed subject matter will be set forth in part in the description that follows, and in part will be obvious from the description, or can be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1A-1B shows representative pressure-temperature curve of multiple process runs of UST treatment at a) 70° C. and b) 40° C. [- Pressure (MPa), --- - Product temperature at shear valve exit (° C.)].

FIG. 2A-2D shows laser scanning microscopy (LSM) images of untreated milk:pea and water:pea suspensions (2A) untreated milk:pea 1:0.5 protein sample—2D image, (2B) untreated milk:pea 1:0.5 protein sample—3D image, (2C) untreated water:pea 0:0.5 protein sample—2D image, (2D) untreated water:pea 0:0.5 protein sample—3D image. The 3D images show height difference with reference color bars.

FIG. 3 shows strain sweep dependency of storage modulus (G′) of milk:pea protein samples at different treatments. Frequency=1 Hz.

FIG. 4A-4C shows frequency sweep analysis of milk:pea protein samples at different treatments (4A) Storage modulus, G′, (4B) Loss modulus, G″ (4C) Tan δ.

FIG. 5 shows viscosity as a function of the shear rate for different samples.

FIG. 6 shows sedimentation index of samples.

FIG. 7A-7D shows images of (7A) untreated milk:pea protein 1:0.5 and 1:3 samples (7B) 70° C. UST treated milk:pea protein 1:0.5 and 1:3 samples (7C) untreated milk:pea protein 1:0.5 and 1:3 samples with pH adjustment upto 4.6 (7D) 70° C. UST treated milk:pea protein 1:0.5 and 1:3 samples with pH adjustment upto 4.6.

FIG. 8A-8F shows laser scanning microscopy (LSM) images at 10× magnification showing the microstructure of (8A) untreated milk:pea protein 1:0.5 samples (8B) untreated milk:pea protein 1:3 samples (8C) milk:pea protein 1:0.5 samples treated by UST—400 MPa—70° C. (8D) milk:pea protein 1:3 samples treated by UST—400 MPa—70° C. (8E) milk:pea protein 1:0.5 samples treated by Homogenization—2000 psi—500 psi—70° C. (8F) milk:pea protein 1:3 samples treated by Homogenization—2000 psi—500 psi—70° C.

FIG. 9A-9F shows scanning electron microscope (SEM) images at 350× magnification (scale bar is 200 m) showing the microstructure of milk:pea protein 1:3 samples (9A) untreated (9B) treated by UST—400 MPa—40° C. (9C) treated by UST—400 MPa—70° C. (9D) treated by HPP—400 MPa—25° C.—0 min (9E) treated by Homogenization—2000 psi—500 psi—70° C. (9F) treated by Thermal treatment—70° C.—0 min.

FIG. 10A-10F shows macroscopic images showing blends of (10A) untreated milk:mung bean protein (10B) UST treated milk:mung bean protein (10C) untreated milk:soy bean protein (10D) UST treated milk:soy bean (10E) untreated milk:mung+soy bean protein (10F) UST treated milk:mung+soy bean protein samples at different protein concentrations. [The dash lines indicate the phase separation i.e. level of sediments in the suspension].

FIG. 11 shows pressure-temperature history of samples during UST treatment.

FIG. 12 shows strain sweep dependency of storage modulus (G′) of samples. Frequency=1 Hz.

FIG. 13A-13C shows strain sweep dependency of storage modulus (G′) of samples. Frequency=1 Hz.

FIG. 14 shows viscosity as a function of the shear rate for different samples.

FIG. 15A-B shows laser scanning microscopy (LSM) images at 10× magnification showing the microstructure of (15A) Untreated and (15B) 70° C. UST treated samples of (i) Raw milk, (ii) Skim milk and (iii) Cream.

FIG. 16A-B shows laser scanning microscopy (LSM) images at 10× magnification showing the microstructure of (16A) Untreated and (16B) 70° C. UST treated samples of (i) Raw milk+Pea protein, (ii) Skim milk+Pea protein and (iii) Cream+Pea protein suspensions.

FIG. 17A-B shows macroscopic observations of samples heat treated at ˜70° C. for 10 min and centrifuged at 4000×g for 30 min at 4° C.

FIG. 18A-B shows volume (%) of different fractions in (18A) Untreated and (18B) 70° C. UST treated samples after centrifugation for 30 min at 4000×g (4° C.).

FIG. 19A-B shows volume (%) of different fractions in (19A) Untreated and (19B) 70° C. UST treated samples heat treated at −100° C. for 10 min followed by centrifugation for 30 min at 4000×g (4° C.).

FIG. 20A-20B shows volume (%) of different fractions in (20A) Untreated and (20B) 70° C. UST treated samples under freeze (−20° C./24 h)-thaw (4° C./12 h) treatment followed by centrifugation for 30 min at 4000×g (4° C.).

### DETAILED DESCRIPTION

The materials, compounds, compositions, and methods described herein may be understood more readily by reference to the following detailed description of specific aspects of the disclosed subject matter and the Examples included therein and to the Figures.

Before the present materials, compounds, compositions, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “a polymer” includes mixtures of two or more such polymers, reference to “the component” includes mixtures of two or more such component, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

The term “milk” is to be interpreted as milk originating from any milk producing mammal, said milk being conventionally used in dairies for the production of dairy products. Accordingly, the term “milk” comprises milk originating from e.g. a cow, a goat, a sheep, a yak, a (water) buffalo, or a camel.

The term “dairy product” is to be interpreted as any kind of product comprising whey proteins. The term “whey proteins” is to be interpreted as the proteins present in milk other than casein.

“Ultra Shear Technology,” also referred to herein as the UST Platform, is based on the use of intense shear forces from ultra-high pressure (greater than 20,000 psi) valve discharge. UST has been shown to turn hydrophobic extracts into stable, water-soluble formulations on a small, laboratory scale. The UST Platform offers the potential to produce stable nanoemulsions of oil-like products in water. The UST platform allows for the creation of stable nanoemulsions of otherwise immiscible fluids (e.g., oils and water), and the preparation of higher quality, homogenized, extended shelf-life or room temperature stable low-acid liquid foods that cannot be effectively preserved using existing non-thermal technologies, e.g., dairy products.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Also, disclosed herein are materials, compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a composition is disclosed and a number of modifications that can be made to a number of components of the composition are discussed, each and every combination and permutation that are possible are specifically contemplated unless specifically indicated to the contrary. Thus, if a class of components A, B, and C are disclosed as well as a class of components D, E, and F and an example of a composition A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

### Methods and Products

Plant Protein/Animal Protein Blends

Health conscious consumers are interested in novel protein-based beverages and products. Plant based proteins are often not easily water-soluble and settle down as sediments during processing and storage, leading to non-uniformity in protein distribution in beverages and mixes. The novel high pressure and shear based ultra shear technology (UST) modifies the particle size in plant protein, combines plant protein with dairy proteins and make them stable. Protein blends of different consistencies could be created for different food applications.

In the present work, a high pressure and shear-based mechanism was used to obtain a homogeneous blend of dairy protein and plant protein. The feasibility was demonstrated with two different liquid food formulations with dairy protein and plant protein.

UST treatment enables blending of proteins from plant-dairy sources. This can prevent sedimentation, alter consistency, and facilitate stability. Different plant-and dairy proteins can be effectively blended to form a homogeneous mass. Different proteins types and proportions result in products with different consistencies.

For example, UST treated plant-animal protein blends were stable over 15 days under refrigerated conditions (Example 1). UST reduced protein-fat particle size (1:0.5 and 1:1) and kept the blend stable with no sedimentation. This allows for the creation of plant-dairy based stable beverages such as milk substitute and functional drinks. It also eliminates the use of stabilizers, emulsifiers to create stable product—clean label product. It also has the advantage of requiring fewer ingredients such as sweetener, sugar, fat etc. due to better dispersibility of particles of reduced size. Nano-sized particles enable digestibility and target delivery of functional components.

All untreated, pressure treated, thermal treated protein blends (1:0.5, 1:1 & 1:3) and homogenized samples (1:0.5, 1:1) showed sediments indicating instability. The water holding capacity is less. Phase separation of proteins occurs from plant and dairy proteins.

At high concentration 1:3, UST bound the protein from different sources together to form a stable (gel) structure with increased water holding capacity. This enables plant-dairy products such as spread, sauce, butter, and mayo-type products. It also eliminated the need for thickeners and application of heat to improve product consistency. The quality of the blend can be preserved at lesser thermal exposure.

UST enables quality retention at less thermal exposure. At lesser thermal exposure, the quality of proteins is retained by prevention of denaturation. Combined protein has improved quality attributes over individual proteins. UST binds protein from plant-dairy source, which enables a homogenous blend of proteins and makes the protein behave as combined protein with modified functional properties.

In the first formulation, milk with 2% fat and 5% pea protein were used as dairy protein and plant protein sources respectively. 5% pea protein (made by mixing protein powder with water) was added to milk and the solution was well-mixed. The temperature was equilateral to 25° C. and the fluid was subjected to high pressure of 400 MPa followed by passing the solution through a tiny clearance. The resulting shear blended the proteins together. After two days of storage under refrigeration, the control (untreated) sample showed sediments of pea protein in the milk while the treated product had homogenized appearance with no sedimentation. Milk protein and pea proteins are thoroughly dispersed in milk due to the treatment.

In the second formulation, 2% chia seed protein (powder mixed with water to make solution), a good source of omega-3 fatty acid and dietary fiber, was added to milk (2% fat) and 5% pea protein solution. After mixing at initial temperature of 25° C., the fluid was subjected to high pressure of 400 MPa and subsequent shearing by passing through a tiny clearance. This resulted in a product with cheese sauce like consistency as well as homogeneous appearance. The texture remained unchanged after two days of refrigerated storage.

The novel process of combining very high pressure and the high shear produced by our idea of rapid expansion through a tiny clearance is unique for this blending of proteins in a single step.

Therefore, disclosed herein is a method of using ultra sheer technology to form a homogenous product from a combination of a plant protein and an animal protein source, the method comprising: combining a plant protein source and an animal protein source; placing the plant protein source and animal protein source under conditions to form a homogenous product, wherein said conditions comprise pressure varying from 2,000 psi to 87,000 psi; and temperature from 5-100° C.; wherein shear enables blending of the animal and plant protein sources to form a homogeneous product.

By “Ultra Shear Technology” (or UST) is meant the use of intense shear forces generated from ultra-high pressure valve discharge. U.S. Pat. No. 10,823,159, herein incorporated by reference in its entirety for its teaching concerning UST, describes how the UST system operates and what equipment is needed to carry out the methods and produce the products disclosed herein.

The pressure used with the methods disclosed herein can be 2,000, 3,000, 4,000, 5,000, 6,000, 7,000, 8,000, 9,000, 10,000, 11,000, 12,000, 13,000, 14,000, 15,000, 16,000, 17,000, 18,000, 19,000, 20,000, 21,000, 22,000, 23,000, 24,000, 25,000, 26,000, 27,000, 28,000, 29,000, 30,000, 31,000, 32,000, 33,000, 34,000, 35,000, 36,000, 37,000, 38,000, 39,000, 40,000, 41,000, 42,000, 43,000, 44,000, 45,000, 46,000, 47,000, 48,000, 49,000, 50,000, 51,000, 52,000, 53,000, 54,000, 55,000, 56,000, 57,000, 58,000, 59,000, 60,000, 61,000, 62,000, 63,000, 64,000, 65,000, 66,000, 67,000, 68,000, 69,000, 70,000, 71,000, 72,000, 73,000, 74,000, 75,000, 76,000, 77,000, 78,000, 79,000, 80,000, 81,000, 82,000, 83,000, 84,000, 85,000, 86,000, or 87,000 psi, or any amount above, below, or in between, as long as it is consistent with the use with UST. A preferred embodiment includes pressure from 50,000 to 60,000 psi.

The temperature used with the methods disclosed herein can be 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100° C., or any amount above, below, or in between, as long as it is consistent with the use with UST. A preferred temperature includes 5-25° C. for a product that is to be refrigerated, and 70-90° C. for a product that is stable at ambient temperatures.

The plant protein can be from any source of plant known to produce protein. Examples include, but are not limited to, common plant milks such as almond milk, coconut milk, rice milk, and soy milk. Other plant protein sources include hemp milk, oat milk, pea milk, and peanut milk. Plant proteins can also be obtained from:
Grains: barley, fonio, maize, millet, oat, rice, rye, sorghum, teff, triticale, spelt, wheat
Pseudocereals: amaranth, buckwheat, quinoa
Legumes: lupin, pea, peanut, soy, mung
Nuts: almond, brazil, cashew, hazelnut, macadamia, pecan, pistachio, walnut
Seeds: chia seed, flax seed, hemp seed, pumpkin seed, sesame seed, sunflower seed
Other: coconut (fruit; drupe), potato (tuber), tiger nut (tuber)

The methods disclosed herein can make use of more than one plant protein source. For example, the plant protein used can be a blend created by mixing two or more types together. Common examples of blends are almond-coconut milk and almond-cashew milk.

The dairy protein source can be obtained from any dairy or milk product. These are a type of food produced from or containing the milk of mammals, most commonly cattle, water buffaloes, goats, sheep, and camels. Dairy products include, but are not limited to:
Milk: Milk is produced after optional homogenization or pasteurization, in several grades after standardization of the fat level, and possible addition of the bacteria Streptococcus lactis and Leuconostoc citrovorum. Milk can be broken down into several different categories based on type of product produced, including cream, butter, cheese, infant formula, and yogurt. Milk varies in fat content. Skim milk is milk with zero fat, while whole milk products contain fat. Also disclosed is scalded milk, condensed milk, evaporated milk, baked milk, dulce de leche, malai, powdered milk (or milk powder, produced by removing the water from milk), khoa (milk which has been completely concentrated by evaporation), infant formula (dried milk powder with specific additives for feeding human infants), high milk-fat and nutritional products. Also included are whey and buttermilk.
The animal protein source can also be from fermented milk. Examples include, but are not limited to, soured milk (obtained by fermentation with mesophilic bacteria), cultured buttermilk resembling buttermilk, clabber, filmjolk, ymer, viili, kefir, kumis, amasi, and mursik.
The animal protein source can also be yogurt based. Yogurt, milk fermented by thermophilic bacteria, mainly Streptococcus salivarius ssp. thermophilus and Lactobacillus delbrueckii ssp. bulgaricus can sometimes include additional bacteria, such as Lactobacillus acidophilus.
The animal protein can also be cream or butter, such as fermented cream, single cream, double cream and whipped cream, clotted cream, sour cream, smetana, or crème fraiche. Also included is ghee smen, and anhydrous milkfat (clarified butter).
Further contemplated is the use of cheese. Examples include, but are not limited to, cheese in general, produced by coagulating milk, separated from whey and ripened, generally with bacteria and sometimes also with certain molds. Also contemplated are rennet-coagulated cheeses, cheddar, grana cheeses, gruyere, blue cheese, brined cheese, washed-rind cheese, acid-set or sour milk cheeses, fresh cheeses and curds, the soft, curdled part of milk (or skim milk) used to make cheese, chhena and paneer, cream cheese, produced by the addition of cream to milk and then curdled to form a rich curd or cheese, and whey cheese (a dairy product made from whey and thus technically not cheese).
Also contemplated is casein, including caseinates, sodium or calcium salts of casein. Contemplated are milk protein concentrates and isolates, whey protein concentrates and isolates, reduced lactose whey hydrolysates, milk treated with proteolytic enzymes to alter functionality.
Also included is custard, ice cream, including milk, flavors and emulsifying additives (dairy ice cream), as well as gelato, ice milk, frozen custard, and frozen yogurt.

Different proportions of plant and animal proteins can be used. For example, the ratio of plant to animal protein can be 0.1:1, 0.2:1, 0.3:1, 0.4:1, 0.5:1, 0.6:1, 0.7:1, 0.8:1, 0.9:1, 1:1, 2:1, 3:1, 4:1, 5:1, 6:1, 7:1, 8:1, 9:1, 10:1, or any amount below, above, or in between these ratios. The ratio of plant to animal protein can also be 1:01, 1:0.2, 1:0.3, 1:0.4, 1:0.5, 1:0.6, 1:0.7, 1:0.8, 1:0.9, 1:1, 1:2, 1:3, 1:4, 1:5, 1:6, 1:7, 1:8, 1:9, or 1:10, or any amount above, below, or in between these ratios.

Importantly, a homogenous product can be created using UST. It has been discovered that these products, while being homogenous, can have varying viscosity depending on conditions and starting products. Different treatment combinations can create different products of different stability and viscosity. One of skill in the art will understand that by varying the conditions and starting material of what is used in the reaction, various outcomes can be achieved. For example, the weight of the protein sources, different combinations of pressure, temperature and shear enable blending of different proportions of proteins of animal and plant sources to form homogeneous products with varying viscosity. Furthermore, the strength of the gel network of the product can increase with temperature. Therefore, to attain a stronger gel, one can increase the temperature of the UST reaction.

In the methods disclosed herein, it is possible to blend animal protein with a relatively high fat content with a plant protein and produce a product that is homogenous and does not form sedimentation or separation (the product itself is discussed in more detail below). Therefore, the animal protein used in the method disclosed herein can comprise 0, 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, 32, 33, 34, 35, 36, 37, 38, 39, or 40% or more fat content. For example, the fat content can be greater than 5, 10, 15, 20, 25, 30, 35, 40, 45, or 50%.

The starting composition of plant and animal protein can be modified based on fat concentration. Furthermore, the consistency of blend of plant and animal protein can be modified based on fat concentration. One of skill in the art will appreciate that the concentration, starting amounts, temperature, and pressure used can vary in order to obtain different products with different consistencies and stabilities. Using the method disclosed herein, however, it has been found that stabilizers are not needed to retain a homogenous blend.

Animal Protein and Animal Fat Blends

The increasing consumer awareness on health-promoting foods has created demand for novel foods containing nutritious proteins and fats from different sources. In addition, the increasing world population has necessitated use of sustainable protein sources. Dairy protein source, especially milk, is widely consumed animal protein-based food conferring several nutritional benefits. In milk processing, the foremost processing requirement is to break down the larger fat globules to smaller and uniform size thereby preventing creaming off. Further, milk is processed commercially by thermal process including HTST pasteurization at 72° C. for ≥15 s and UHT sterilization at 135-150° C. for short holding time, for instance, 140° C. for 2.3 s (Tunick et al., 2016). Several studies have used high pressure and shear based mechanism to stabilize milk products, inactivate bacteria, enzymes and promote structural changes in the milk proteins (Thiebaud et al., 2003; Hayes et al., 2005; Pereda et al., 2007; Roach & Harte, 2008).

Pea protein is a common ingredient in plant-based foods due to high nutritional content, affordability, and sustainability (Lam et al., 2018). In recent years, pea proteins are considered suitable ingredient to replace animal proteins in beverages (Boukid et al., 2021). Blending pea and dairy proteins would be an economical way to obtain nutritional as well as sustainable protein-based foods. However, inclusion of pea protein in protein-based foods is challenging due to its poor functional performance, often resulting in separation and sedimentation of pea protein particles in the food matrix.

Ultra shear technology (UST), also referred as high pressure homogenization (HPH), is a high pressure based technique for continuous processing of liquid foods. The process involves exposure of liquid food to high pressure of about 400 MPa and sudden depressurization by passing through a tiny gap in a shear valve. The instant pressure drop leads to conversion of pressure energy to kinetic energy which generates several physical forces such as shear, turbulence or cavitation. These forces facilitate useful functions such as particle size modification, emulsification, mixing, microbial, enzyme inactivation, etc. in the foods.

Mixtures of dairy and plant proteins such as sodium caseinate—soy protein (Ji et al., 2015), whey protein isolate—pea protein isolate (Ho et al., 2018), and pea protein isolate—whey protein isolate (Hinderink et al., 2019) have been emulsifying ingredients to stabilize oil-based emulsions such as soy oil, canola oil, sunflower oil. Under these circumstances, the ingredients were used as minor ingredients. On the other hand, when dairy and plant proteins requires blending or used as the primary ingredient, food scientists and technologists faces multiple hurdles including sedimentation of plant proteins due to poor functionality, separation of milk fat. This results in unacceptable non-homogenous product. Therefore, it is critical to develop innovative technological solutions to attain stable and homogenous blend. Such technology should reduce product thermal exposure so that health promoting bioactive compounds present in these liquid foods can be preserved. To satisfy consumer demand for removing synthetic chemicals from processed foods, the liquid foods should be free from stabilizers or emulsifiers. Such products that are free from synthetic chemicals and preservatives are often referred in the industry as clean label products.

Disclosed herein is a high pressure based continuous flow process called “ultrashear technology (UST) to blend plant and dairy protein sources to produce stable products without emulsifiers. In addition, the technology can help to create wide range of textures (simple liquid to complex gel like structures) within the liquid foods being processed. In an earlier study, as described above and in Example 1, the feasibility of using UST for blending dairy-plant protein liquid foods is described. As described herein and in Example 2, it is also possible to blend products with varying fat content.

In dairy products, the amount of fat content is associated with perceived creaminess and is positively related to the sensorial product liking (McCarthy et al., 2017). In addition, the fat content is also related to the apparent viscosity (Akhtar et al., 2005) and dispersion rheology of products (Chojnicka-Paszun et al., 2012). Therefore, the variation in fat content in plant-dairy protein blends is a critical element in designing dairy-plant protein blend since it could alter the rheological behavior and stability characteristics of the product.

In Example 2, the feasibility of ultrashear technology to process plant-dairy protein blends with different fat content in order to improve the product quality characteristics was studied. The quality attributes were characterized in terms of viscoelastic characteristics, microstructure, particle size, pH, zeta potential and stability.

In summary of Example 2, milk with different fat contents were used as animal protein source and pea protein was used as plant protein source. Raw milk (˜4.3% fat) was obtained from Waterman dairy farm—Ohio state university, Columbus, Ohio. The raw milk was separated into skim milk (˜0.5% fat) and cream (˜35-40% fat) fractions using a cream separator. Thus, milk with 3 different fat content viz., raw milk, skim milk and cream were obtained.

Suspensions of animal and plant protein source in 1:1 protein ratios, but with different fat concentrations, varied by use of milk with different fat content were prepared. Thus, three suspensions, namely, i) Raw milk:Pea 1:1 protein, ii) Skim milk:Pea 1:1 protein, iii) Cream Pea 1:1 protein, were prepared. The suspensions were well-mixed and hydrated for 3 hours.

The high pressure and shear based blending of the suspensions were performed in a laboratory scale high pressure based ultra shear technology (UST) equipment. For the purpose, the suspensions equilibrated to initial temperatures of 25° C. were taken and subjected to high pressure of 400 MPa and associated shear treatment by passing through a tiny clearance through shear valve. The process temperature during the UST treatment was kept at 70° C.

The pressure associated shear and temperature altered the microstructure of fat, protein particles in the suspensions and blended plant-animal protein sources together (Appendix). The process reduced the fat-protein particle size and promoted interaction of fat and protein in different combinations (including raw milk:pea, skim milk:pea and cream:pea blends) thus creating homogenous and stable products. Dairy protein-fat combinations also (without pea protein) also created similar stable emulsions.

The combination of high pressure, shear and temperature in mechanism enabled modification of the textural characteristics of the blends depending on the milk fat concentrations in suspensions. The viscosity increased with increasing milk fat content, thus resulting in products with possibly varied functionalities. Furthermore, the viscosity of UST treated blends decreased with increasing shear rate. The product(s) have potential to be used as spread, sauce type applications.

The stability of the UST treated emulsions were assessed by accelerated tests for emulsion stability, heat stability and freeze-thaw stability. Accelerated testing conditions include centrifugation of samples at 4000×g for 30 min at 4° C. and observing the percentage of sediment, blend (homogenous mass), serum (light liquid) and cream (fat) portions. The heat stability analysis of the samples was performed by boiling at 97±3° C. for 10 min. The freeze-thaw stability analysis involved freezing the samples at −20° C. for 24 h and subsequent thawing at 4° C. for 12 h.

The raw milk:pea and skim milk:pea suspensions treated by the UST blending mechanism showed no separation of pea protein or fat, thus indicating stable blends. The cream:pea samples showed minor serum/liquid separation from the blends. Though no separation of pea protein and fat content was observed in the blends after boiling treatment, subsequent centrifugation of the samples in above-mentioned conditions indicated light serum separation in the raw milk:pea protein and skim milk:pea protein samples and fat separation in cream:pea blend. There was no separation or sedimentation in the blends after freeze-thaw treatment. However, subsequent centrifugation of the samples in above-mentioned conditions showed serum (or light liquid) separation in the raw milk:pea, skim milk:pea and cream pea blends.

Based on these findings, disclosed herein is a method of using ultra sheer technology to form a homogenous product from a combination of an animal protein and an animal fat source, the method comprising: combining an animal protein source and an animal fat source; placing the animal protein source and an animal fat source under conditions to form a homogenous product, wherein said conditions comprise pressure varying from 2,000 psi to 87,000 psi; and temperature from 5-100° C.; wherein shear enables blending of the protein and fat sources to form a homogeneous product. In these methods, much like those described herein for a combination of plant protein and animal protein, different proportions of animal protein source and an animal fat source can be used. Example 2 provides an example of how this can be accomplished.

The animal fat and/or animal protein can be from a dairy source. Examples include, but are not limited to, cow milk, cream, whey, goat milk and butter milk. The animal protein and animal fat can be from different sources, such as different animals (cow and goat, for example), different products from the same animal (cow cheese and cow milk, for example), or the same product with different properties (skim milk and whole milk, for example).

In particular embodiments, the protein source can have less than 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, 32, 33, 34, 35, 36, 37, 38, 39, or 40% fat, and the fat source can have greater than 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, 32, 33, 34, 35, 36, 37, 38, 39, or 40% fat. In other words, the protein and the fat source can differ from each other.

The animal protein to animal fat starting ratio can range 0.1:1, 0.2:1, 0.3:1, 0.4:1, 0.5:1, 0.6:1, 0.7:1, 0.8:1, 0.9:1, 1:1, 2:1, 3:1, 4:1, 5:1, 6:1, 7:1, 8:1, 9:1, 10:1, or any amount below, above, or in between these ratios. The ratio of animal protein to animal fat can also be 1:01, 1:0.2, 1:0.3, 1:0.4, 1:0.5, 1:0.6, 1:0.7, 1:0.8, 1:0.9, 1:1, 1:2, 1:3, 1:4, 1:5, 1:6, 1:7, 1:8, 1:9, or 1:10, or any amount above, below, or in between these ratios by weight.

As disclosed above in relation to animal and plant protein, weight of the protein and fat sources, and different combinations of pressure, temperature and shear enable blending of different proportions of proteins of protein and fat sources to form homogeneous products with varying viscosity.

It has also been found that when using the method disclosed herein, high fat and high protein blends can have a flowability which differs significantly from that when a mixture which is obtained without the use of UST is obtained. The products disclosed herein can be 1, 2, 3, 4, 5, 6, 7, 8, 9, 10, 15, 20, 25, 30, 35, 40, 45, 50, 55, 60, 65, 70, 75, 80, 85, 90, 95, or 100% or any amount above, between, or below more flowable compared to a product produced using the same starting material but not subjected to the methods disclosed herein.

### Products

### Plant Protein/Animal Protein Products

Disclosed herein is a product made by the process of using ultra sheer technology to form a homogenous product from a combination of a plant protein and an animal protein source, the method comprising: combining a plant protein source and an animal protein source; placing the plant protein source and animal protein source under conditions to form a homogenous product, wherein said conditions comprise pressure varying from 2,000 psi to 87,000 psi; and temperature from 5-100° C.; wherein shear enables blending of the animal and plant protein sources to form a homogeneous product.

The product disclosed herein can be a liquid, such as a beverage, a smoothie, or a protein shake. It can also be a food product, such as ice cream, butter, cheese, yogurt, sauce, cream, or gel, such as a jelly. It can be a plant-dairy-based spread product, or a plant-dairy based egg substitute. The product can be a solid, such as a dehydrated, powdered, or solid product. An example is a protein powder for mixing into smoothies or shakes. Further disclosed herein are nutritional formulations in powder form which are reconstitutable with a liquid.

Importantly, when using UST to form the products disclosed herein, no addition of synthetic binding agents to prevent separation of plant and animal protein components are required. Furthermore, no addition of synthetic stabilizing agents to keep the product stable are required. This is significantly different than the products currently available. When compared to a product produced from a method that does not involve UST, the products disclosed herein are 10, 20, 30, 40, 50, 60, 70, 80, 90, or 100% more homogenous and more shelf-stable. In fact, the products disclosed herein are stable, with no sedimentation, for up to 5, 10, 15, 20, 25, 30, or more days under refrigeration, or on the shelf for those compositions that are “shelf stable.” By “no sedimentation” is meant that less than 0.1, 0.2, 0.3, 0.4, 0.5, 0.6, 0.7, 0.8, 0.9, or 1, 2, 3, 4, or 5% of the product forms sedimentation.

### Animal Fat and Animal Protein

Furthermore, disclosed herein is a product produced by the method disclosed herein, wherein the product is a combination of animal protein and animal fat. Any of the animal proteins or animal fats disclosed herein can be used to achieve this product. The product produced can therefore comprise only animal products, where, for example, one is higher in protein content and one is higher in milk content. Example 2 details a method by which such a product can be achieved. The product produced can comprise 5, 6, 7, 8, 9, 10, 11, 12, 13, 14, 15, 16, 17, 18, 19, 20, 21, 22, 23, 24, 25, 26, 27, 28, 39, 30, 31, 32, 33, 34, 35, 36, 37, 38, 39, or 40% or more fat content. For example, the fat content can be greater than 5, 10, 15, 20, 25, 30, 35, 40, 45, or 50%.

The product comprising of an animal fat and an animal protein can comprise a spread, gel, ice cream mix-type product, sauce, cream-substitute, cheese-type products, or mayonnaise-type product, for example. The protein, fat, or functionality of the product can differ from a standard composition in consistency, flowability, stability, or actual particle size. When using the methods disclosed herein to obtain a product, the actual particle size of the product is reduced compared to that of a standard product which has not been subjected to the methods disclosed herein. For example, the product produced by the methods disclosed herein can be 0, 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, 32, 33, 34, 35, 36, 37, 38, 39, 40, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100% more flowable, or pourable. This can result in an increased palatability to the consumer.

The particle size of the product produced by the method disclosed herein can be significantly smaller than that of a product produced without using the method disclosed herein. The particle size can be 0, 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, 32, 33, 34, 35, 36, 37, 38, 39, 40, 45, 46, 47, 48, 49, or 50% smaller, or any amount below, above, or in between these amounts.

### Optional Components

While it is not necessary to add stabilizing agents in order to prevent separation or sedimentation, there are many formulations which can optionally be added to the product disclosed herein. For example, the product may also comprise other ingredients that can modify the chemical, physical, hedonic or processing characteristics of the products or serve as pharmaceutical or additional nutritional components when they are used by certain target populations.

Many of these optional ingredients are known or otherwise adapted for use in other food products and may also be used in the nutritional formulations in accordance with the invention, on condition that these optional ingredients are safe and efficient for oral administration and are compatible with the other essential ingredients of the selected product.

Nonlimiting examples of such optional ingredients comprise preserving agents, antioxidants, emulsifiers, buffers, pharmaceutical active agents, additional nutrients, dyes, flavorings, thickeners and stabilizers, etc.

The nutritional formulations in powder or liquid form may also comprise vitamins or associated nutrients, such as vitamin A, vitamin E, vitamin K, thiamine, riboflavin, pyridoxine, vitamin B12, carotenoids, niacin, folic acid, pantothenic acid, biotin, vitamin C, choline, inositol, salts thereof and derivatives thereof, and combinations thereof.

The nutritional formulations in powder or liquid form may also comprise minerals, such as phosphorus, magnesium, iron, zinc, manganese, copper, sodium, potassium, molybdenum, chromium, selenium, chloride, and combinations thereof.

The nutritional formulations in powder or liquid form may also comprise one or more masking agents to reduce, for example, the bitter tastes in reconstituted powders.

Suitable masking agents comprise natural and artificial sweeteners, sources of sodium, such as sodium chloride, and hydrocolloids such as guar gum, xanthan gum, carrageenan, and combinations thereof.

The amount of masking agent in the nutritional formulation in powder form may vary as a function of the particular masking agent selected, the other ingredients of the formulation and other formulation variables or target products.

The product produced by the methods disclosed herein can be a food product, and therefore can be edible. In an embodiment the product may be used as a food with an animal, whether a human or other animal. In one embodiment the product is edible by a human. In another embodiment the food product is edible by domesticated animals. The food product can have organoleptic qualities, and can be shelf stable or refrigerated. Shelf stable refers to food products that when stored under ambient conditions (such as 72° F. in typical commercial packaging for such products) are safe for consumption, and remain palatable.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1: Method for Blending Animal and Plant Protein Liquid Mixtures with Improved Food Functionality: Influence of Protein Content

Disclosed herein is a novel high pressure, thermal and shear-based method to obtain a homogeneous, and stable blend of different proportions of proteins from animal and plant origin.

### 1) Materials and Methods

i) Materials

Milk (2% fat, 3.3% protein) was purchased from local supermarket (Kroger Co., OH) and stored refrigerated until use. Pea protein powder with 80.00% protein was purchased from Judee's Gluten Free (DeJa' GF Foods, Plain City, OH) and filtered through sieves to obtain particle sizes of 500-600 microns. Bicinchoninic acid (BCA) assay kit (Pierce Biotechnology Inc., Rockford, IL) with BCA reagent A and B, Bovine serum albumin (BSA) were used in protein solubility analysis.

ii) Ultra-Shear Technology Laboratory Tester

A custom fabricated benchtop UST laboratory tester (PBI, Easton, MA, USA) described by Janahar et al. (2021) was used for ultra shear treatment experiments. The equipment involves a pressure chamber where the fluid pressure is increased up to 400 MPa. The pressurized fluid is decompressed by passing through a shear valve, which comprises a spherical ceramic ball placed on a circular seat. When the fluid pressure overcomes the force on the ball, the fluid flows through the gap between the ball valve and seat through an outlet tube to be collected. Pressure transducer and thermocouples are fitted at several locations and the data was recorded using a data acquisition system (PBI, Easton, MA, USA).

iii) Methods

(a) Preparation of Milk-Pea Protein Suspensions

Milk and different amounts of pea protein was added to prepare suspensions of milk and pea protein. Suspensions with three different protein concentrations, varied by the approximate amount of milk protein to pea protein ratio, viz., Milk:Pea—1:0.5, 1:1 and 1:3 were prepared. The suspensions were well-mixed and hydrated by continuous stirring for 3 hours.

(b) Ultra Shear Treatment

To study the influence of interaction of pressure+shear and pressure+shear+temperature, milk-pea suspensions were treated by UST at 400 MPa. Initial temperatures of 15±2° C. and 25° C.±2° C. were used to achieve 40 and 70° C. UST process temperature respectively at exit of shear valve. For a typical process run (or cycle) of UST treatment, about 2.5 to 3 mL of temperature preconditioned milk:pea suspensions were fed into the pressure chamber of the UST laboratory tester to be compressed to 400 MPa followed by passage through shear valve and the samples were collected upon exit the shear valve. Samples collected were immediately placed in ice-water bath and stored at <5° C. until analysis. Flow rates of milk:pea suspensions were 1.23-1.32 g/s throughout study. Multiple process runs were run continuously to collect required sample for analysis.

iv) Control Samples

The untreated milk:pea suspensions of three different protein ratios viz., 1:0.5, 1:1 and 1:3 were used as (no-treatment) control.

To study the pressure-only effect, experiments were performed in batch type HPP equipment (PT1, Avure Technologies, Kent, WA, USA) as described earlier by Dhakal et al. (2016). Pouches containing milk:pea suspensions (˜2.5 mL) at an initial temperature of 13±2° C. were processed at 400 MPa pressure for holding time of 0 min (come-up time) at a process temperature of 25±2° C.

To study the contribution of temperature-only effect, thermal treatment was performed at 70° C. for 0 min.

To investigate the influence of conventional homogenization process, two stage homogenization representing normal manufacturing conditions for dairy products were used (Schmidt & Smith, 1988). Milk:pea suspensions were processed at pressure of 2000 psi (13.79 MPa) in first stage and 500 psi (3.45 MPa) in second stage at temperature of 70° C. in a two stage homogenizer (Model NS2002H, GEA Niro Soavi, Parma, Italy).

v) Characterization of Processed Milk-Pea Protein Suspensions

The quality attributes of samples were characterized using particle size, zeta potential, pH, dynamic rheological measurements, sedimentation index, protein solubility and microstructure.

(a) Morphology and Particle Size

The morphology of the samples and particle size were characterized using a Laser microscope (Laser Microscope 3D & Profile measurements, Keyence, VK-x200 series, Osaka, Japan). About 5 μL of samples were placed on a glass slide and spread as a thin layer and allowed to air dry at room temperature for 12 h. For each sample, at least three images were captured at 10× magnification with VK viewer software in ‘Easy Mode’. Further analysis of the images was performed to characterize the particles by mean diameter and average height using VK-Analyzer software (Keyence v3.3.0.0). To measure the mean diameter, it was assumed that each particle, represented by dark black area, in the 2D image had a circular shape. The contour of each fat-protein particle was fitted using the 3-point diameter function to obtain the diameter. At least 20 measurements were obtained for each image and averaged to calculate the mean diameter. The height denotes the vertical distance between the flat base of the glass slide where the samples were spread to the top edge of the particle. The measurement of average height was performed based on confocal profiling in the laser microscope (Funke et al., 2015). The laser microscope allowed capture of 3D images to analyze the height of particles.

To compare the contribution of particle diameter in milk to the particle size parameters in milk:pea suspensions, the particle size parameters of water:pea suspensions with similar amount of pea protein added in milk:pea protein suspensions were measured.

(b) Zeta Potential

Zeta potential measurements of all samples diluted with ultra-pure water in the ratio of 1:1000 were performed in a zeta potential analyzer (NanoBrook, ZetaPALS, Brookhaven, Holtsville, NY). The electrophoretic mobility of particles was measured using Phase Analysis Light Scattering technique with a detection angle of 15°. Smoluchowski model was used determine zeta potential from mobility data.

(c) pH

The sample pH were measured using a benchtop pH meter (Mettler-Toledo, USA).

(d) Dynamic Rheological Measurements

The dynamic rheological characterization of samples were performed in a Discovery HR3 hybrid rheometer (TA instruments, New Castle, DE, USA). A parallel plate geometry with plate diameter of 40 mm and inter-plate gap of 1000 μm was used and the temperature was kept at 25° C. using a Peltier system. Strain sweep measurements were carried out between 0.1 and 1000% strain at a frequency of 1 Hz to determine the linear viscoelastic range. The strain in linear viscoelastic region (1%) was selected and frequency sweep was performed with frequency ranging from 0.1 to 100 rad/s. The elastic or storage modulus (G′), viscous or loss modulus (G″), tangent of phase angle, δ (tan δ=G″/G′) and complex viscosity (η*) were obtained as a function of the angular frequency (ω), which indicate the equilibrium conditions and physical stability of the blends (Martínez-Monteagudo et al., 2017). Steady state flow measurements were carried out at increasing shear rates from 0.1 to 100 s⁻¹ to measure the shear viscosities of samples. Measured viscosities indicate the impact of protein concentrations and different processing on the flow behavior and stability. Rheological data were obtained directly from the TRIOS software (TA Instruments, New Castle, DE, USA). Measurements were made in triplicates and average was reported.

(e) Sedimentation Index

Sedimentation index was determined using method described by Kubo et al. (2013) with minor modification. 15 mL centrifuge tubes with 10 mL samples were stored at 5° C.±1 for 15 days. The volume of the supernatant milk phase because of the sedimentation of pea protein solid particles and the sediment volume were measured every 24 h. The sedimentation index (%) was determined using the following equation:

$$Sedimentation index ( \% ) = ( \frac{Sediment volume}{Total sample volume} ) \times 100 \qquad ( 1 )$$

(f) Protein Solubility

Protein solubility was determined according to the method of Boye et al. (2010) with slight modification. The samples (5 ml) were taken in 15 ml tubes and centrifuged at 4000 g for 60 min at 20° C. in Sorvall Legend XFR centrifuge (Thermo Scientific, Waltham, USA). Protein in the initial sample and supernatant portion after centrifugation was determined using the bicinchoninic acid (BCA) assay kit (Pierce Biotechnology Inc., Rockford, IL) (Smith et al., 1985) using Bovine serum albumin (BSA) as protein standard. The samples were diluted 1:1000 (v/v) with distilled water to get the range of concentrations that fit the standard curve. For the BCA assay, 25 μL of standard or sample and 200 μL of working reagent (50 parts of BCA reagent A and 1 part of BCA reagent B) were added into wells in a micro plate and incubated at 37° C. for 30 min. The absorbance was measured at 562 nm with Fisherbrand accuSkan GO UV/Vis Spectrophotometer (Thermo Fisher Scientific, Waltham, MA). Blank values were determined by analyzing distilled water with no protein and the blank absorbance values were subtracted from the sample absorbance values. The sample absorbances were substituted in the equation obtained from standard curve to obtain the protein concentration. Protein solubility is given as the percent ratio of protein in the supernatant to percent ratio of the total protein in the sample before centrifugation.

(g) Microstructure

The juice microstructure was evaluated using laser microscope and scanning electron microscope (SEM).

For laser microscope analyses, samples (5 μL) were carefully placed onto a glass slide and spread as a thin layer and allowed to air dry at room temperature for 12 h. The microstructure was observed with lens of 10× magnification by 2D and 3D images obtained by a non-contact 3D Laser Scanning Microscope (VK-X200 series, Keyence, Osaka, Japan).

For SEM analysis, Thermo Scientific Quattro Environmental Scanning Electron Microscope (ESEM) was used. The samples were frozen by immersion in liquid nitrogen and freeze-dried (VirTis Benchtop K, model #2KBTES, SP Scientific, PA, USA). Afterwards, all the samples were mounted using carbon tape on aluminum stubs (SPI Supplies), sputtered with gold in Pelco Model 3 sputter coater and analyzed under SEM at a voltage of 5 kV, current of 0.18 nA and pressure of 0.001 Pa at 350× magnification.

vi) Evaluating the UST Feasibility on Different Plant-Dairy Protein Blends

Additional studies were carried out that versality of UST treatment in blending plant proteins of diverse sources. Tests utilized different plant protein sources such as mung bean, soy bean, Chia, and Chickpea. Different protein suspensions were prepared, and UST treated using procedures mentioned earlier.

vii) Statistical Analysis

All the analysis were carried out in triplicate, unless mentioned otherwise. The significance of analysis results with respect to different treatments, protein concentrations and interactions was investigated by general linear model (GLM) univariate ANOVA at a significance level of 0.05 using SPSS (version 27, IBM SPSS Statistics, Armonk, NY). For each treatment, the effect of different protein concentrations on analysis results were determined by ANOVA and Tukey Honest Significance Difference (HSD) test was applied to compare means.

### 2) Results and Discussion

i) Pressure-Thermal History of UST Treated Samples

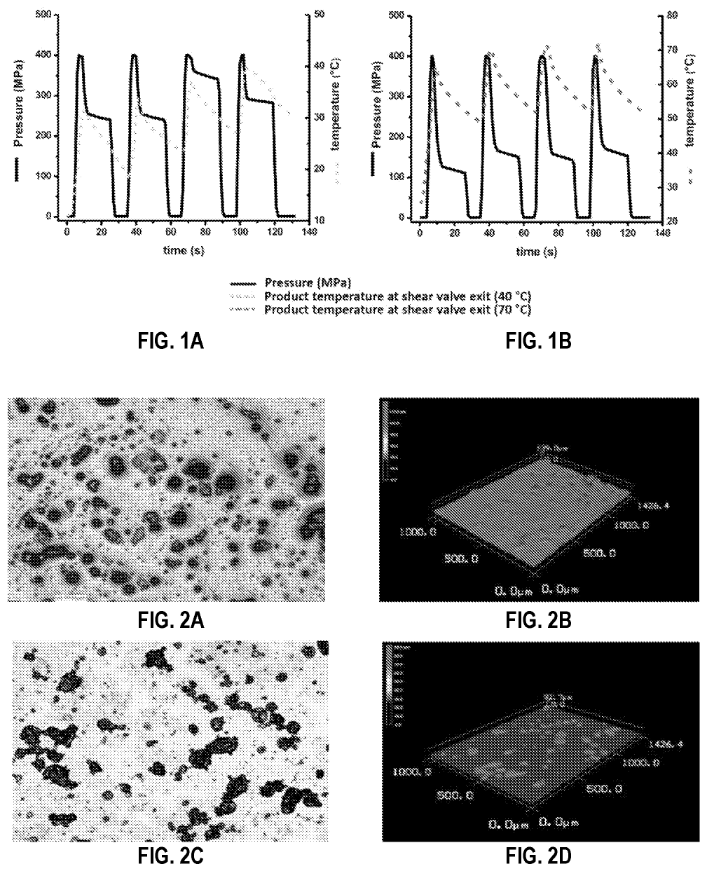

The representative pressure-temperature curves of UST treatment at 70° C. and 40° C. are shown in FIG. 1a-b. The temperature of product at shear valve is the result of initial temperature, temperature rise in pressure chamber, temperature rise in shear valve and heat loss to surrounding components. Firstly, the product temperature transiently increases under pressure (Rasanayagam et al., 2003) in the pressure chamber of the UST unit. Subsequently, the product temperature increases instantaneously as it passes through the shear valve. This temperature rise is due to the pressure drop (ΔP), leading to conversion of pressure energy to kinetic energy which is partly dissipated as heat energy. The temperature rise due to shearing was theoretically estimated as 26.20° C./100 MPa and 26.25° C./100 MPa for initial temperatures of 25° C. and 15° C. respectively (Janahar et al., 2021). Actual temperature within UST equipment may be lower than theoretical temperature rise due to heat loss to the environment as well as energy expended to modify liquid structure including particle size reduction. In 70° C. UST treatment, the shear valve was heated to 70° C. to minimize heat loss to surrounding. On the other hand, in 40° C. UST treatment the shear valve was wrapped by a cooling pad mechanism to maintain the treatment temperature below 40° C. to investigate pressure shear only effects.

In 70° C. UST treatment, a process temperature of 71.33±0.95° C. was reached at a flow rate of 1.23±0.16 g/s and a temperature rise per second of 8.85±0.94° C. was observed. In 40° C. UST treatment, a process temperature of 36.82±3.10° C. was reached at a flow rate of 1.32±0.16 g/s and a temperature rise per second of 6.49±0.24° C. was observed. In both 70 and 40° C. UST experiments, the samples were collected from third process run to allow the fluid temperature to reach the desired process temperature and eliminate the fluid from dead volume.

ii) Particle Size Characterization and Morphology

The impact of the pressure, shear, temperature, and interactions on the particle size parameters namely, mean diameter and average height are shown in Table 1. In untreated milk:pea samples at protein ratios from 1:0.5 to 1:3, the mean diameter of particles varied between 31.90 and 37.89 μm and the average height varied between 58.34 and 87.36 μm with no significant differences between protein ratios. The average diameter values were close to the average diameter of 39.50 μm for commercial pea protein isolate, reported by Osen et al. (2014).

After 40° C. UST treatment, for milk:pea samples at 1:0.5 and 1:1 protein ratio, the mean diameter reduced significantly (P<0.05) up to 2.48 and 2.56 μm respectively and average height reduced significantly (P<0.05) up to 8.54 and 10.40 μm respectively. For milk:pea samples at 1:3 protein ratio the mean diameter and average height were 23.06 μm and 56.58 μm respectively, significantly higher than the low protein samples and not significantly different from untreated samples. Similarly, after 70° C. UST treatment of milk:pea 1:0.5 and 1:1 protein samples, the mean diameter reduced significantly (P<0.05) up to 3.83 and 4.63 μm respectively and average height reduced significantly (P<0.05) up to 13.43 and 20.15 μm respectively. For milk:pea 1:3 protein samples, the mean diameter and average height were 44.10 μm and 29.98 μm respectively, which were significantly higher than the low protein samples and not significantly different from untreated samples.

During UST treatment, the work done by pressurization (pdV) is converted to kinetic energy as the fluid passes through the tiny gap in the shear valve. Part of the energy is dissipated as heat energy and part of the energy is used modifying liquid food structure including particle size reduction. This led to creation of homogenous and stable plant-animal protein blends.

The effect of the UST—generated physical forces on the fluid product depends on the properties of the product. For instance, the increasing protein concentrations resulted in increased particle size. At high protein (milk:pea 1:3) suspensions, UST treatment disintegrates the larger particles into smaller particles. This leads to increase in interfacial area and interactions between closely located milk protein, fat and plant protein molecules. These high shear-promoted interactions cause flocculation, coalescence or aggregation phenomena of the tiny particles, thereby increasing the particle size. The reduction of particle size in low protein suspensions and increase in particle size in high protein suspensions indicate possibility of presence of a threshold protein ratio or a corresponding threshold viscosity which could result in decrease or increase of particle size and the product consistency (discussed below).

It was also noted that for milk:pea 1:3 protein samples, 70° C. UST treatment caused significantly higher (P<0.05) particle diameter than the 40° C. UST treatment. This indicated the effect of temperature in UST on the particle size modification in the sample. Protein-stabilized emulsions could flocculate at high temperature as the protein-protein associations bind the particles together in a network (Sliwinski et al., 2003). Further, the pea particles have globular proteins adsorbed to the surfaces which may naturally have a relatively high surface hydrophobicity. These proteins may become more hydrophobic due to surface disturbances or thermal denaturation (McClements et al., 2019). The shear led surface changes to the proteins and the pressure-shear-temperature led protein denaturation might have resulted in increased particle size in high protein samples treated by 70° C. UST. Our results demonstrated the feasibility of formulating liquid foods with varying consistency and food structure by suitably varying protein concentration and UST treatment parameters.

Batch HPP treatment did not cause significant changes in mean particle diameter and average height for all protein ratios. Several researchers have reported that HPP at pressures up to 600 MPa and holding times up to 3 min does not cause significant reduction in the average fat globule size in milk (Huppertz et al., 2003; Ye et al., 2004; Stratakos et al., 2019) and cream (Dumay et al., 1996) as compared to untreated samples. The particle size of 5.0% whey protein isolate mixture did not significantly change after HPP treatment at 450 MPa for 3.5 min at 5-10° C. (Zhang et al., 2020). Likewise, the thermal treatment did not create significant change in the particle size parameters of suspensions, making the temperature contribution in particle size change negligible. Dhakal et al. (2016) reported that the average particle diameters of almond milk treated at 72° C. (for 300 and 600 s) did not alter significantly as compared to raw almond milk.

After homogenization treatment of milk:pea 1:0.5 and 1:1 protein samples, the mean diameter reduced significantly (P<0.05) up to 10.79 and 11.15 μm respectively. The diameters were lesser than untreated samples but greater than UST treated samples and these samples eventually exhibited sedimentation of pea protein particles during storage (discussed herein). For milk:pea 1:3 protein samples, the mean diameter was significantly higher at 24.89 μm, but not significantly different from untreated samples. These samples had viscosities less than UST treated milk:pea 1:3 samples (discussed below).

FIG. 2a clearly indicate the larger pea protein particles as circular dark structures and intermittent tiny dark spots, indicated by light green color in 3D image (FIG. 2b). In FIG. 2c, the tiny dark spots in the white region are not observed and this region is shown in blue color (lesser height) in FIG. 2d. Thus, the tiny dark spots in the white region in the FIG. 2a can be attributed to the milk fat-protein content. The comparison of untreated milk:pea and water:pea suspensions showed that the mean diameter and average height of milk:pea and water:pea suspensions were not significantly different (Table 2). This indicated that the contribution of milk fat and protein to the particle size parameters of untreated milk:pea samples were negligible.

The interaction of pressure, shear and temperature in UST altered the particle size, resulting in product of different consistencies, based on the initial properties of the suspension.

Thus, the negligible role of pressure-only and temperature-only on the particle size characterization is demonstrated.

iii) Zeta Potential

The zeta potential indicates magnitude of charge on a colloidal particle. The terms ‘increase or decrease’ are not used algebraically and represent the increase or decrease of numerical value of zeta potential. The zeta potential of samples are given in Table 3. The different treatments, protein ratio and interactions had significant effect on the zeta potential of samples (P<0.05). The zeta potential of untreated samples of milk:pea suspensions from 1:0.5 to 1:3 ranged from −43.83 to −47.87 mV. The isoelectric point of pea proteins and casein protein in milk are 4.5 and 4.6 respectively (Tomé et al., 2015). The pH of all samples were apparently above the isoelectric point and this was responsible for the negative values of zeta potential. In untreated, HPP and thermal treated samples the zeta potential of milk:pea 1:3 samples were significantly higher (P<0.05) than the other samples. This might be due to increased protein concentration in 1:3 samples. Further, the higher zeta potential of thermally treated samples as compared with other samples might be due to rearrangement of the protein particles or network caused by heat exposure (Sejersen et al., 2007).

In 40 and 70° C. UST treated samples, the zeta potential values decreased respectively from −46.23 to −29.16 mV and −46.70 to −34.32 mV with increasing protein ratios from 1:0.5 to 1:3 in milk:pea blends. A significant decrease (P<0.05) in zeta potential with increasing protein concentration under UST treatment was noted. This might be because, the UST treatment could make the charged amino acid residues move from the surface of the protein to its interior and/or create protein-protein linkage, thus masking negative charges (Relkin & Shukat, 2012). Similar behavior of decrease of zeta potential of samples due to UST treatment was reported by Janahar et al. (2021) in raw milk and this was attributed to the surface modifications in proteins caused by pressure associated shear. The values obtained for high protein (milk:pea 1:3) samples were closer to −23.6 mV and −30 mV observed for hazelnut milk (Bernat et al., 2015) and almond milk (Bonsegna et al., 2011; Gallier et al., 2012) respectively. At milk:pea protein ratio of 1:3, the zeta potential after 70° C. UST was higher than 40° C. UST, which might be attributed to relatively higher protein conformational changes possibly effected by UST temperature and increased particle size in 70° C. UST treatment. Relkin and Shukat (2012) reported increases in surface charge characteristics in parallel with increases in the particle sizes in protein systems.

The zeta potential of homogenized samples varied from −44.41 to −37.66 mV with decreasing value with increasing protein concentration. The decreasing trend was similar to UST treatments and might be attributed to similar surface modifications in proteins caused by shear and cavitation generated by homogenization (Meena et al., 2016). Thus, the knowledge on zeta potential values of different milk:pea protein suspensions demonstrate the influence of composition, surface modifications of particles, protein conformational changes, particle size changes and rearrangement of particle networks when treated by different processing technologies.

iv) pH

The pH of untreated milk:pea samples of different protein ratios varied from 6.70 to 6.73 with no significant difference between protein ratios (Table3). The pH of milk:pea samples treated using different processes were not significantly different from untreated samples, in consistence with earlier research (Pereda et al., 2007; Janahar et al., 2021). Above the isoelectric point, the pea globulins are not dissociated completely and so the surface-active material of the protein is less available for adsorption at the interface of fat-protein (Gharsallaoui et al., 2009). In addition, the structure of casein micelles were changed by treatments only at pH lower than natural milk pH (Huppertz et al., 2018). Therefore, the pH variation and its effect in particle conformational changes and particle interactions can be negligible.

v) Dynamic Rheological Measurements

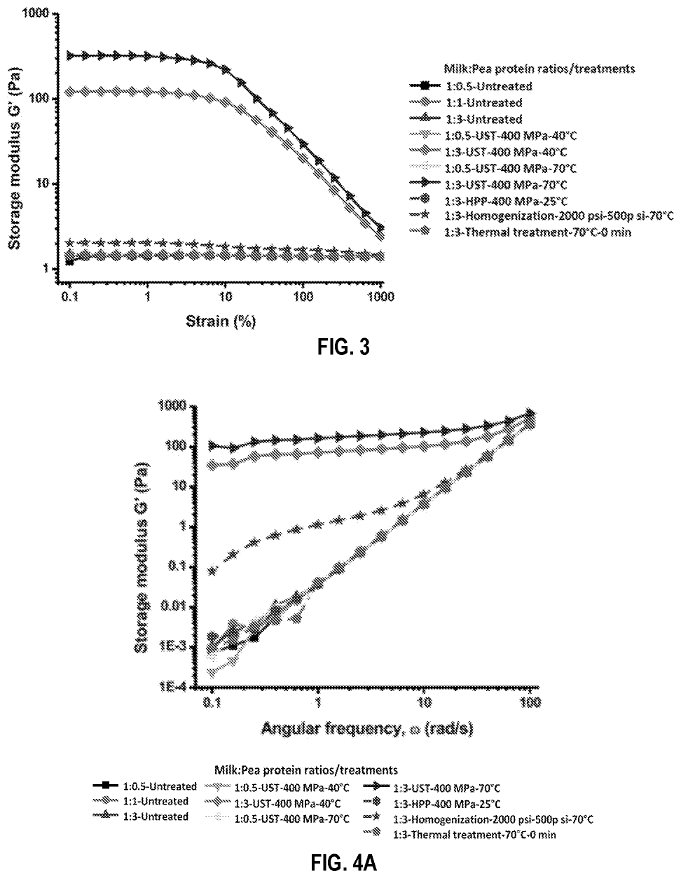

Strain sweep. The storage modulus (G′) as function of strain for different samples treated by different processes is shown in FIG. 3. For untreated, HPP, thermal and homogenization treatments, all the milk:pea samples from 1:0.5 to 1:3 protein ratios showed a linear relationship with strain. For UST treatments, milk:pea samples with 1:0.5 and 1:1 protein ratios showed linear relationship with strain, however milk:pea 1:3 samples showed distinct linear and nonlinear regions (FIG. 3).

The UST treatments of milk:pea 1:3 samples resulted in higher values of G′ when compared with untreated, HPP, thermal and homogenization treated samples of all protein ratios. This evidenced that UST created protein-protein networks of higher strength in milk:pea 1:3 samples. Judging by the magnitude of G′, the 70° C. UST treatments of milk:pea 1:3 samples provided highest gel strength, which could be attributed to the conformational changes to proteins, and particle interactions contributed by thermal effects during UST. Further, for both 40 and 70° C. UST treatments, the transition from linear to non-linear region for milk:pea 1:3 protein ratio samples were around 5% strain, which is the yielding point. This critical strain indicates the transition from viscoelastic solid to viscoelastic liquid which might be due to the breakdown of the secondary network of particles (Hesarinejad et al., 2014).

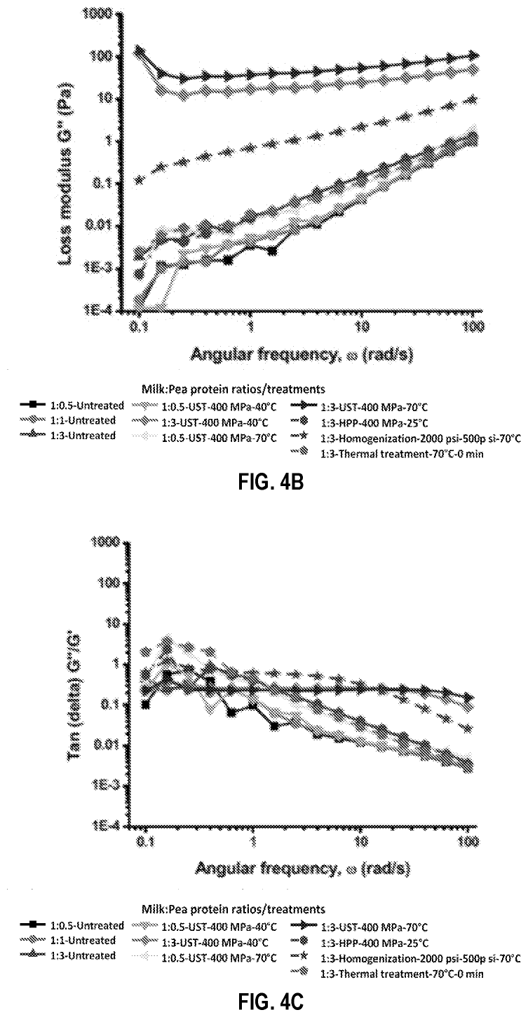

Frequency sweep. Based on the information obtained from strain sweep analysis, the limits of the viscoelastic region were defined and 1% strain was used for frequency sweep measurements. FIG. 4a-c shows the storage modulus (G′), loss modulus (G″) and tangent of phase angle (tan δ) as a function of angular frequency.

The change of G′ and G″ with respect to frequency would point out difference between solution or gel-like structure and thus can be used to characterize a dispersion such as emulsion, gel, foam and cross over (Xiu et al., 2011). In the present study, the magnitudes of both G′ and G″ increased with frequency for all samples and treatments. For the untreated, HPP, thermal treatments of all samples and homogenization treatments of 1:0.5 and 1:1 milk:pea samples, the values of G′ and G″ were nearly constant at low frequencies and the values increased with frequency. This behavior typically represents a dilute solution (Martínez-Monteagudo et al., 2017). Homogenization of milk:pea 1:3 samples resulted in slightly higher values of G′ and G″ indicating a deviation from dilute solution.

UST treatment of samples at 40 and 70° C. resulted in higher G′ and G″ values with increased protein ratios from 1:0.5 to 1:3 (FIG. 4a-b). Notably, in both 40 and 70° C. UST treatments of milk:pea 1:3 samples, the values of G′ and G″ were clearly higher than rest of the samples. The values of 70° C. UST was higher than 40° C. UST which might emphasize the role of temperature of UST treatment for desirable texture formation in products. Thus, UST could increase the gel strength based on protein concentration and process temperature used. Shand et al. (2007) studied the thermal properties of pea protein slurry (10% protein w/w) using differential scanning calorimetry (10° C./min heating rate) and reported two major endothermic peaks at 67.1±1.8° C. and 85.1±0.4° C. Sun and Arntfield (2010) determined the denaturation temperature of commercial pea protein isolate (10.5% w/v) as 72.92° C. Mession et al. (2013) reported that the thermal denaturation of low-denatured pea proteins begins at temperature slightly below 70° C. In addition, the initial denaturation temperatures of whey proteins in milk are 62, 64 and 72° C. for a-lactalbumin, bovine serum albumin and immunoglobulin G respectively (Lee, 1992). The partial thermal denaturation of proteins in milk and pea could have caused conformational changes in proteins and create protein-protein linkages, thereby creating gel network of higher strength. It's interesting to note that, in water and pea suspensions where milk was replaced by water, the G′, G″ and viscosities were much lesser than the milk:pea suspensions with similar protein contribution by pea under UST treatments (data not shown). Thus the role of milk proteins and fat in the rheological characteristics of milk:pea suspensions is indispensable.

Further, values of G′ were higher than G″, which indicated that milk:pea 1:3 samples treated by UST 40 and 70° C. has dominant elastic than viscous properties. Therefore, the product can be classified as a weak gel (Martínez-Monteagudo et al., 2017).

FIG. 4c presents the change of loss factor i.e. tangent of phase angle (tan δ) with respect to angular frequency which is used to determine the structural stability of the samples. When the loss factor is higher, the proportion of dissipated energy due to viscous flow under external stress is the higher (Xiu et al., 2011). For all the samples and treatments, the tan δ were less than unity, which indicate predominant elastic behavior. Further, tan δ decreased with increasing frequency, indicating the rise of elastic behavior (Xiu et al., 2011). In milk:pea 1:3 protein samples treated by UST 40 and 70° C., tan δ almost kept constant for a longer range of frequency. This indicated the higher strength of gel structure of samples treated by UST. The clear tendency of UST to form macromolecular networks and complex structures as compared to other treatments is demonstrated in the measurements. The results also corroborate the differences in particle sizes created by UST treatment as discussed above.

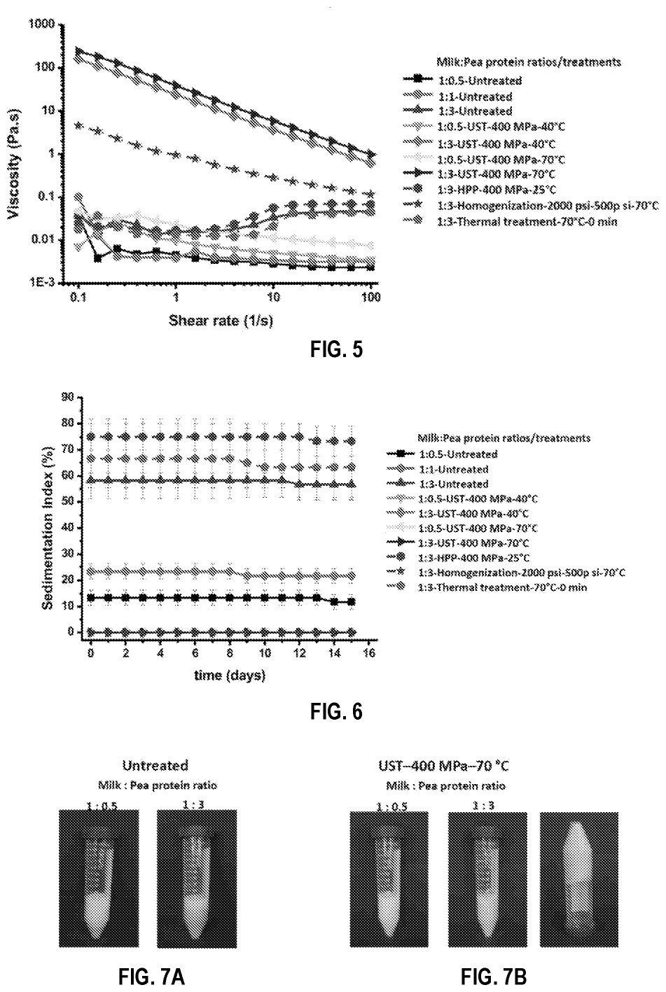

Flow sweep. In the flow sweep measurements at shear rates of 0.1-100 s⁻¹, the viscosities showed varying behavior with different samples and treatments (FIG. 5). For milk:pea protein at 1:0.5 and 1:1 ratios, untreated, HPP, thermal and homogenization treatments showed nearly constant viscosities with increasing shear rate. For 1:3 milk:pea samples, the untreated, HPP and thermal treatment produced near constant viscosities at rates up to ˜5 s⁻¹ and increasing viscosities at shear rates over ˜5 s⁻¹, although less pronounced.

For milk:pea 1:3 samples treated by 40 and 70° C. UST treatments, the viscosities were largely higher and exhibiting shear-thinning behavior (FIG. 4c). This support the ability of pressure and associated shear and temperature in UST to increase the viscosity of milk:pea blends by creating complex molecular interactions and promoting shear and temperature led flocculation of samples. The suspensions of flocculated particles generally exhibit shear-thinning behavior. When the shear rates are lower, the hydrodynamic forces are insufficient to break the bonds between particles in the flocs. Thus, the viscosity is unchanged. When the shear rate is higher, the hydrodynamic forces are enough to disrupt the bonds and deform the flocs. Thus, the viscosity is reduced.

The viscosity of treated samples depended on the protein concentration, applied pressure, and the shear intensity. For instance, the viscosity of low protein samples (milk:pea 1:0.5, 1:1) were less than high protein (milk:pea 1:3) samples. Additionally, the viscosity of homogenization treated milk:pea 1:3 samples was less than UST treated milk:pea 1:3 samples. The plant-animal protein blends samples of varying viscosity treated by pressure associated shear based on protein concentration, pressure, and shear intensity resembled products such as liquid beverages, smoothie, protein shake, cream-type product, sauce-type product, gel-type product, butter-type, jelly-type product, spread-type product, egg-substitute type product.

vi) Sedimentation Index

FIG. 6 shows the sedimentation index for the untreated samples and samples processed by different treatments under refrigerated storage for 15 days. The samples with no exposure to pressure and shear such as untreated, HPP and thermal treated samples showed sedimentation within the first 24 hours of storage under refrigeration. With increasing milk:pea protein ratios from 1:0.5 to 1:3, the sedimentation index of untreated, HPP and thermal samples varied from 11.67 to 58.33%, 18.33 to 75.00%, 11.67 to 66.67%. Sedimentation is contributed by the larger particle size in milk:pea suspensions and inability of the milk matrix to keep the pea particles in suspension. The amount of sedimentation depended on the amount of pea protein added. It was noted that the HPP treatment resulted in significantly different sedimentation index values than untreated samples for milk:pea 1:1 and 1:3 samples. This might indicate the effect of HPP to alter the conformation of fat and protein macromolecules and induce flocculation in milk:pea suspensions. Dickinson and James (1998) indicated that HPP could induce significant levels of flocculation in model oil-in-water emulsions stabilized by P-lactoglobulin and the level of pressure-induced flocculation could be controlled by changing the intensity of the HPP. Janahar et al. (2021) reported that HPP of raw milk at 400 MPa for 0 min at 40.66±0.82° C. showed excessive creaming compared to untreated milk due to pressure induced formation of larger milk fat clusters.

Conventional homogenization of milk:pea 1:05 and 1:1 samples prevented sedimentation only up to 2 days after which the sedimentation index increased up to 11.67 and 18.33% respectively, indicating that the particle size reduction by homogenization is insufficient to create stable product.

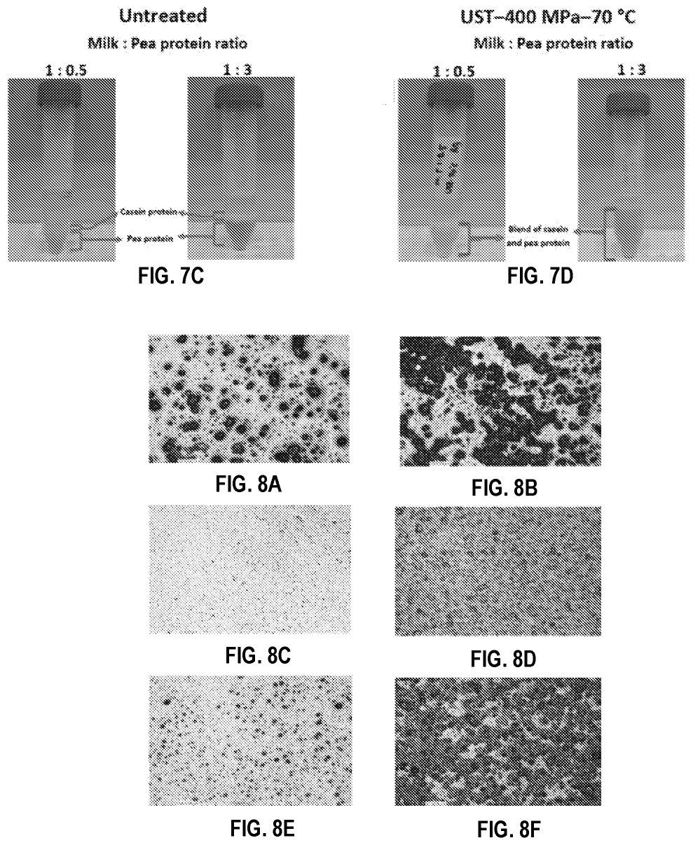

The UST treatment at 40 and 70° C. prevented sedimentation in all milk:pea samples with 0% sedimentation index up to 15 days. In milk:pea protein 1:0.5 and 1:1 samples, this could be due to reduced fat-protein particle size caused by the pressure associated shear in UST. In milk:pea 1:3 samples, the stability could be attributed to the increased viscosity of the blend caused by pressure associated shear. The UST treated samples did not need stabilizers or synthetic additives to prevent sedimentation. According to Stokes Law, the particle sedimentation velocity is directly proportional to its diameter, the acceleration imposed and the difference of density between the particle and dispersant medium and inversely proportional to the dispersed medium viscosity (Kubo et al., 2013). The presence of sedimentation in untreated samples is shown in FIG. 7a and absence of sedimentation in UST (70° C.) treated samples is shown in FIG. 7b. To confirm the particle interactions and blending ability of UST treatment, the pH of the samples were adjusted to 4.6 using dil. HCl and centrifuged at 4000×g for 30 min at 20° C. The untreated samples showed separation of casein protein and pea protein (FIG. 7c), while the UST treated samples showed thorough blending of casein and pea protein particles (FIG. 7d).

vii) Protein Solubility

The protein solubility provides useful information on effective utilization of the products in various food applications (Boye et al., 2010). The solubilities of milk:pea samples of different protein ratios treated by different treatments are shown in Table3. Analysis of variance indicated that the influence of different treatments were significant while protein concentration and interaction of protein concentration and treatment were not significant. The recorded solubilities agreed with previous reports by Shand et al. (2007) and Osen et al. (2014) for commercial pea protein isolates. However, the relatively lower solubility could be because of initial denaturation in the pea protein during manufacturing process. The untreated milk:pea samples of 1:0.5, 1:1 and 1:3 protein ratios were 28.23, 22.67 and 17.27% respectively. Protein solubilities of samples treated by the HPP, thermal and homogenization treatments were not significantly different from untreated samples.

The solubilities of 70° C. UST treated samples varied from 31.28 to 34.47% and were significantly higher than untreated samples, although not significantly different from 40° C. UST treated samples. Thus, effect of pressure associated shear and temperature effect during UST on solubility is evident. The solubilities could be increased because the shear treatment caused size reduction of large protein particles and caused rearrangements in the protein aggregates, thus enabling protein-solvent interaction, and making the proteins accessible for solubilization (Chen et al., 2016; Moll et al., 2021).

viii) Microstructure

The microstructure of the samples were observed using laser scanning microscope and scanning electron microscope analysis.

(a) Laser Scanning Microscope (LSM)

FIG. 8 shows the microstructures of milk:pea samples of 1:0.5 and 1:3 protein ratios under different treatments, obtained by LSM. The untreated milk:pea 1:0.5 samples showed individual pea protein particles dispersed in the milk matrix (FIG. 8a). In untreated milk:pea 1:3 samples, the pea protein particles were linked together due to higher concentration of pea protein (FIG. 8b). There was a clear difference between the untreated milk:pea 1:0.5 samples and 70° C. UST treated samples (FIG. 8c), demonstrating the role of UST in reducing the particle size of samples in order to make the blend stable. 70° C. UST treatment of milk:pea 1:3 samples produced complex protein-protein or protein-fat interactions, resulting in a homogenous product (FIG. 8d). As stated earlier, the network might be a result of aggregation of small particles created by shear treatment. Formation of small particles through disruption and subsequent fragmentation increases the surface area of the particles and changes the properties of the particles and serum, to promote complex interactions (Augusto et al., 2012).

Homogenization appeared to reduce the particle size in milk:pea 1:0.5 samples (FIG. 8e), but the reduction was apparently lesser than that produced by UST treatment. In milk:pea 1:3 samples, homogenization blended milk and pea protein components, though the association were different from that created by UST. The observations in microstructure (FIG. 8) corroborated the particle size measurements discussed below.

(b) Scanning Electron Microscope (SEM)

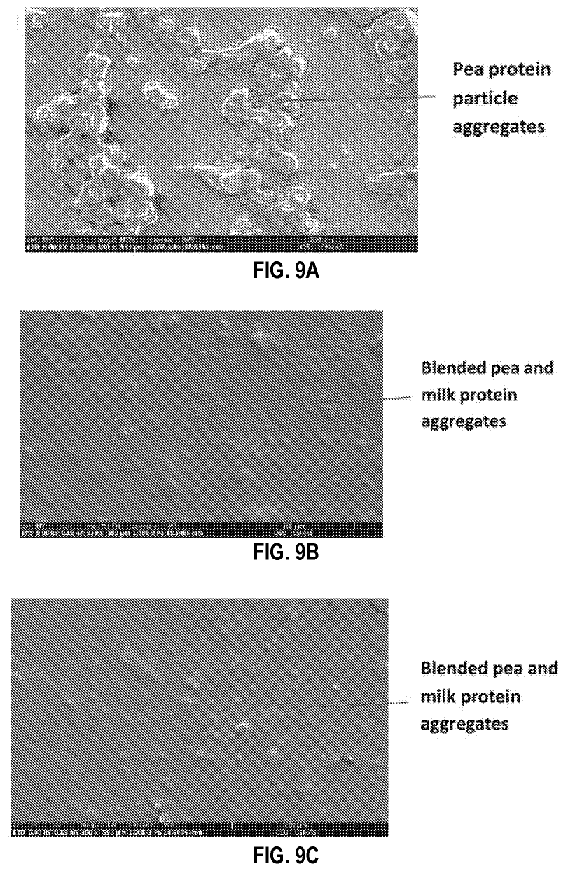

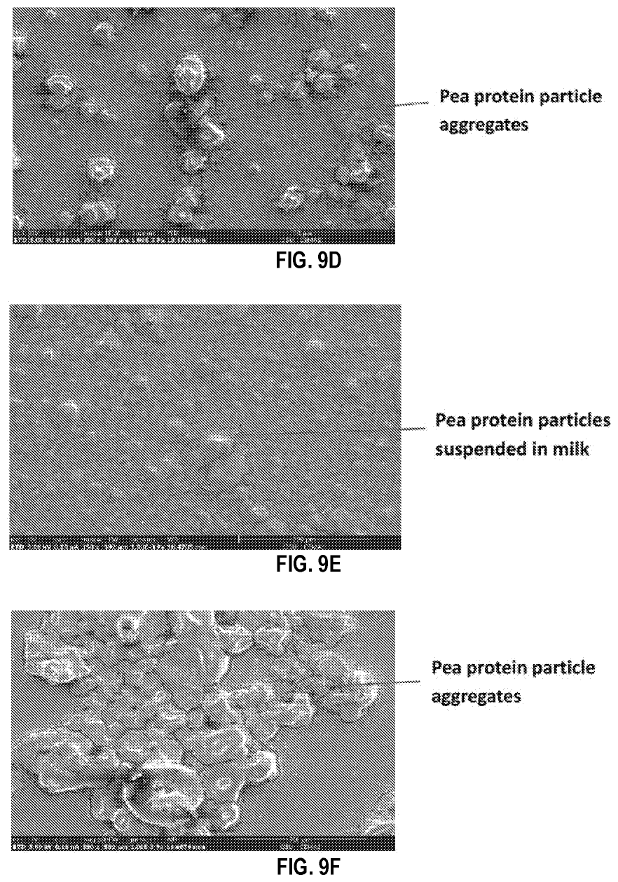

The microstructures of milk:pea samples of 1:3 protein ratio under different treatments, obtained by SEM is given in FIG. 9. In the untreated samples the individual pea protein particles were larger and are apparently clustered together (FIG. 9a). After 40 and 70° C. UST treatment, the pea protein particles were size-reduced, dispersed and appeared enwrapped in the milk matrix (FIG. 9b,c). There was a clear difference between the UST treated and untreated samples which might be attributed to the UST induced particle disruption and subsequent fragmentation. The exposed cell constituents enable interactions between particles such as proteins and changes the properties of particles and serum (Augusto et al., 2012; Kubo et al., 2013).

The HPP treated samples showed individual pea protein particles dispersed in milk indicating that HPP did not affect the size of pea protein particles (FIG. 9d). Homogenization caused disruption of pea protein particles; however, the gel structure is different than the UST treatments (FIG. 9e). After thermal treatment, there was no change in the pea protein particle size even though the particles seemed to be aggregated together (FIG. 9f). The observations corroborated the particle measurements, sedimentation index and rheological changes discussed in earlier sections.

ix) Applicability to Different Plant Protein:Dairy Protein Blends

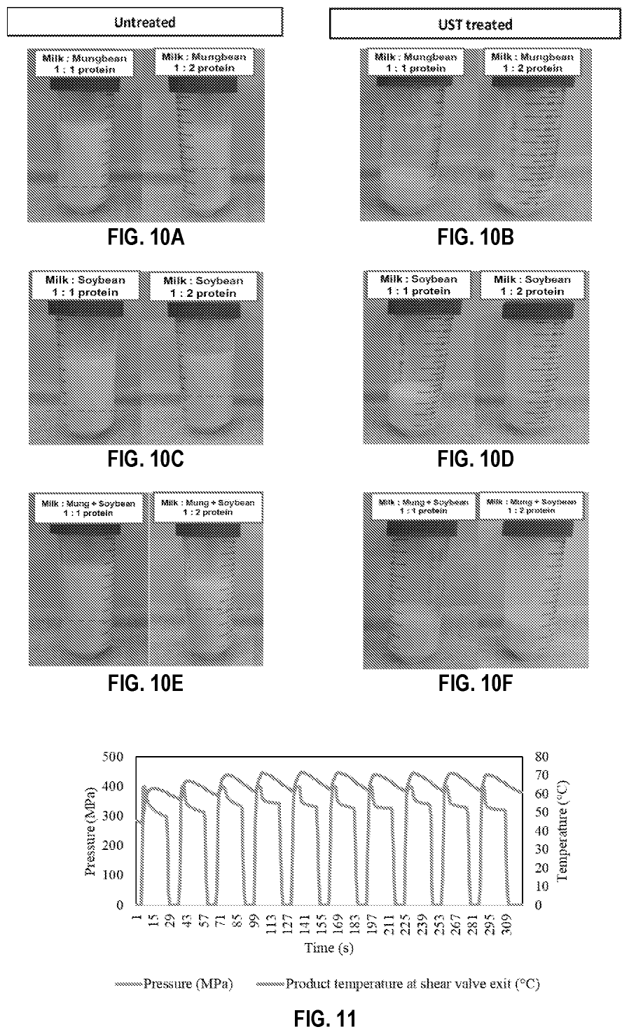

FIG. 10 presents the macroscopic images of plant-dairy protein blends prepared with different plant protein sources like mung bean, soy bean and mixtures. The untreated samples showed sedimentation of plant protein particles in milk (FIG. 10a, c, e). UST treatment prevented the sedimentation phenomena in all samples (FIG. 10b, d, f).

After UST treatment, milk:mung bean protein blends with 1:1 protein ratio had consistency resembling batter, sauce type product and samples with 1:2 protein ratio had a non-flowable consistency resembling a pasta, noodle type product. The blend of mung bean and milk also provides opportunity to create and plant-animal protein-based egg substitute type product.

Samples of UST treated milk:soy bean protein with 1:1 protein ratio had the consistency of milk and it could be a potential milk substitute. Samples with 1:2 protein ratio had a thicker consistency similar to cream or sauce type product.

Similarly, the UST treatment produced products of different consistencies depending on the protein concentrations of mixed proteins like milk, soy bean, mung bean and chia seed protein. Thus, different plant protein sources including pea, chia, soy, mung bean, cashew, almond, peanut etc. could be used to prepare the plant-dairy protein blends. Further, different animal protein sources such as cow milk, cream, whey, goat milk, butter milk etc. can be used in plant-animal protein blends using UST. The blends also provide opportunity for further dehydration and preparation of plant-dairy protein blended dry mixes.

### 3) Conclusion

The relative impact of different process parameters (pressure, shear and temperature) and their interactions along with variation in concentration of dairy-pea suspension during UST was investigated. Pressure-only and thermal-only treatments did not alter the particle size and caused sedimentation of pea protein particles in milk matrix, resulting in an unstable mixture. UST treatment of milk-pea suspensions altered the particle size and created particle-particle interactions thus creating products of varied consistencies with potentially different applications. At lower milk:pea protein ratios of 1:0.5 and 1:1, the UST treated products were stable and represent plant-dairy based milk, cream, sauce type beverage. At high milk:pea protein ratio of 1:3, the UST treatment produced stable products of higher viscosity, representing plant-dairy butter, gel type product. The ability of UST to create stable product and gel network between particles based on the initial protein concentration and due to interaction of pressure, shear and temperature is identified. Moreover, the UST enables clean label product due to no addition of synthetic binding agents to prevent separation of pea and milk protein components. This information is valuable for development of milk-pea protein based products for varied end-use. Further, the rheological characteristics of the milk-pea suspensions under pressure, shear, temperature and their interactions were studied. This information is useful to UST equipment engineers to design equipment components such as shear valve, hold tube, pumps to handle the product.

### Example 2: Methods for Blending Animal and Plant Protein Mixtures with Improved Functionality: Influence of Fat Content

1. Materials and Methods

1.1. Preparation of Dairy Protein Source with Different Fat Content

Raw milk was obtained from The Ohio State University Dairy Farm, Columbus, Ohio and transported at <5° C. to the OSU Emerging Food Process Technology pilot plant within 30 min. The raw milk (˜4.3% fat, ˜3.1% protein) was heated to 50-60° C. and separated into cream (˜35% fat, ˜2.5% protein) and skim milk (˜0.5% fat, ˜3.1% protein) using a cream separator (Model: Elecrem 1, Elecrem, Vanves, France). Thus, dairy protein source with 3 different fat contents viz., raw milk, skim milk and cream were obtained and stored at ≤4° C. for a maximum of 24 h before further treatments and analysis.

1.2. Preparation of Model Plant-Dairy Protein Suspensions with Different Fat Content

To prepare model plant-dairy protein suspensions with different fat contents, dairy protein source with different fat content viz., 100 ml of raw milk, skim milk and cream were taken in 500 ml beakers. To each raw milk, skim milk and cream, similar quantity of pea protein was added, representing approximately 1:1 dairy:pea protein ratios. Thus, three model suspensions of dairy and plant protein source, but with different fat contents were prepared, namely, i) Raw milk+Pea protein, ii) Skim milk+Pea protein, iii) Cream+Pea protein. The suspensions were allowed to hydrate for 3 hours.

1.3. Ultra Shear Technology Treatment

A custom fabricated UST laboratory tester (PBI, Easton, MA, USA) was used. The equipment configuration was described previously by Janahar et al. (2021). For UST process run, the plant-dairy protein suspension was equilibrated to an initial temperature of 25±2° C. and fed into the pressure chamber where the fluid was pressurized up to 400 MPa. The fluid was subsequently passed on to a shear valve where it was quickly depressurized and expelled through an outlet tube. The process temperature during UST treatment was maintained at 70° C. Only test samples from 3^{rd} process run onwards were collected to allow the product temperature to reach the desired process temperature. The samples were immediately cooled down to <5° C. after UST treatment by placing in an ice-water bath. The flow rate of the fluid through the UST shear valve was 1.34±0.62 g/s. Pressure and temperature data were recorded using a data acquisition system (PBI, Easton, MA, USA).

1.4. Analysis

The quality attributes of samples were evaluated, after resting time of about 12 h after UST treatments, using dynamic rheological measurements, microstructure, particle size, pH, zeta potential, and stability.

1.5. Dynamic Rheological Measurements

The rheological characterization of samples were performed using a Discovery HR3 hybrid rheometer (TA instruments, New Castle, DE, USA). A parallel plate geometry with plate diameter of 40 mm and inter-plate gap of 1000 μm was used and the temperature was kept at 25° C. using a Peltier system. Three types of tests were performed: strain sweep, frequency sweep and flow sweep.

parallel plate geometry with a 40 mm diameter and a gap of

1000 mm was used for all measurements.

Strain sweep. Strain sweep measurements were carried out between 0.1 and 1000% strain at a frequency of 1 Hz to determine the linear viscoelastic range. The strain sweep establishes the extent of the material's linearity.

Frequency sweep. The strain in linear viscoelastic region (1%) was selected and frequency sweep was performed with frequency ranging from 0.1 to 100 rad/s. The elastic or storage modulus (G′), viscous or loss modulus (G″), and tangent of phase angle, δ (tan δ=G″/G′) were obtained as a function of the angular frequency (ω), which indicate the equilibrium conditions and physical stability of the blends (Martínez-Monteagudo et al., 2017). Based on the data from strain sweep analysis, 1% strain was selected for frequency sweep measurements.

Flow sweep. Steady state flow measurements were carried out at increasing shear rates from 0.1 to 100 s⁻¹ to measure the shear viscosities of samples. Measured viscosities indicate the impact of protein concentrations and different processing on the flow behavior and stability.

Rheological data were obtained directly from the TRIOS software (TA Instruments, New Castle, DE, USA). Measurements were made in triplicate and average was reported.

1.6. Microstructure and Particle Size Characterization

The microstructure was observed using laser microscope. Samples (5 μL) were carefully placed onto a glass slide, spread as a thin layer and allowed to air dry at room temperature for 12 h. The microstructure was observed with lens of 10× magnification and 2D and 3D (laser+optical) images were obtained by a non-contact 3D Laser Scanning Microscope (VK-X200 series, Keyence, Osaka, Japan). VK-Analyzer software (Keyence v3.3.0.0) was used to analyze the images.

To characterize the particle size, at least three images (area: 1426×1069 μm) were analyzed using VK-Analyzer software (Keyence v3.3.0.0) and the mean diameter and average height of particles were determined. To measure the mean diameter, the contour of each fat-protein particle was assumed circular and fitted using the 3-point diameter function. At least 20 diameter measurements were obtained and averaged. The measurement of average height of particles was performed on the 3D images based on confocal profiling in the laser microscope.

1.7. pH and Zeta Potential

The pH of samples were measured at 23±2° C. using a benchtop pH meter (Mettler-Toledo, USA). For zeta potential measurements at this pH, all samples were diluted with ultra-pure water in the ratio of 1:1000 and placed in a zeta potential analyzer (NanoBrook, ZetaPALS, Brookhaven, Holtsville, NY). The electrophoretic mobility of particles was measured using Phase Analysis Light Scattering technique with a detection angle of 150 and Smoluchowski model was used convert the mobility data into zeta potential values.

1.8. Stability

The stability of the samples was determined in three different ways. This include emulsion stability, heat stability and freeze-thaw stability.

1.8.1. Emulsion Stability

The emulsion stability of the samples were analyzed employing centrifugal force to accelerate the occurrence of instability phenomena such as sedimentation or creaming. The method described by Baier et al. (2015) was followed, with slight modification. 5 mL of each sample taken in graduated centrifuge tube were centrifuged at 4000×g for 30 min at 4° C. in Sorvall Legend XFR centrifuge (Thermo Scientific, Waltham, USA) and the volumes of separated milk fat, sediment and serum were determined.

The volume fractions were calculated according to the following equations:

$$Volume of sediment ( \% ) = ( \frac{Volume of sediment}{Total volume} ) \times 100 \qquad ( 2 )$$

$$Volume of blend ( \% ) = ( \frac{Volume of blend}{Total volume} ) \times 100 \qquad ( 3 )$$

$$Volume of serum ( \% ) = ( \frac{Volume of serum}{Total volume} ) \times 100 \qquad ( 4 )$$

$$Volume of seperated milk fat ( \% ) = ( \frac{Volume of seperated milk fat}{Total volume} ) \times 100 \qquad ( 5 )$$

Here, sediment refers to pea protein sediment in the suspension, blend refers to blend of milk fat+serum, blend of milk fat/serum+pea protein and serum refers to milk/liquid portion with no separated fat or pea particles.

It is important to evaluate the stability of UST treated samples with various post-consumer treatments such as heating the UST treated samples at consumer house hold or freezing and thawing cycle by the consumers. The following tests were carried out.

1.8.2. Heat Stability

When consumer receive UST treated liquid foods (such as cheese sauce), it may require certain heating. It is important to understand product stability under such circumstances.

Samples were evaluated for their thermal stability at ˜100° C. (97±3° C.) for 10 min using a temperature controlled hot water bath. The come up time for the temperature was ˜4 min. Then the samples in centrifuge tubes were centrifuged at 4000×g for 30 min at 4° C. in Sorvall Legend XFR centrifuge (Thermo Scientific, Waltham, USA). The different volume fractions were calculated using equations 2-5.

1.8.3. Freeze-Thaw Stability

To determine the freeze-thaw stability of the samples, the samples were incubated in a freezer (−20° C.) for 24 h and subsequently thawed at refrigerated condition (≤4° C.) for 12 h. Then the samples were centrifuged at 4000×g for 30 min at 4° C. in Sorvall Legend XFR centrifuge (Thermo Scientific, Waltham, USA). The different volume fractions were calculated using equations 2-5.

1.9. Statistical Analysis

All measurements were carried out in triplicate, unless mentioned otherwise. To evaluate the influence of fat content, UST treatment and interactions a General Linear Model (two-way ANOVA) analysis was performed using IBM SPSS Statistics 27 (IBM Corporation, Armonk, USA) software package. For each treatment, one way ANOVA was performed to identify the effect of different samples on quality attributes. Tukey Honest Significance Difference (HSD) test was applied for comparison of means. Statistical significance was considered as P≤0.05.

3. Results and Discussion

3.1. Pressure-Thermal History of Ultra Shear Technology Treated Samples

The pressure-thermal history of samples processed by 70° C. UST treatment is given in FIG. 11. During UST processing, the product temperature transiently increases at a rate of approximately 3° C. per 100 MPa due to heat of compression (Rasanayagam et al., 2003). Subsequently, the product temperature increases during passage through the shear valve due to the instantaneous pressure drop (ΔP). The sudden pressure drop leads to conversion of pressure energy to kinetic energy which generates physical forces such as shear, turbulence, cavitation and dissipated as heat energy (Hayes & Kelly, 2003). Thus, the temperature of product at exit of shear valve is determined by the following relation.

Tₚ=Tᵢ+ΔTₐ+ΔTₛ−ΔTₗ (6)

Where, Tᵢ is initial temperature, ΔTₐ is temperature rise due to heat of compression, ΔTₛ is the temperature rise in shear valve and ΔTₗ is the heat loss to surrounding components.

In the present study, the temperature rise due to shearing was 11.46° C./100 MPa, which was less than the theoretical estimate of 26.20° C./100 MPa for 25° C. initial temperature (Janahar et al., 2021). Earlier researchers reported temperature rise in the range of ˜14 to 19° C./100 MPa (Hayes & Kelly, 2003; Pereda et al., 2007; Zamora et al., 2012 Martínez-Monteagudo et al. 2017). The difference could be attributed to equipment geometry of different equipment. From FIG. 11, it can be seen that the temperature increases instantly as the product flows through the shear valve at the pressure of 400 MPa. The instant temperature rise would help to reduce product thermal exposure during treatment.

3.2. Dynamic Rheological Measurements

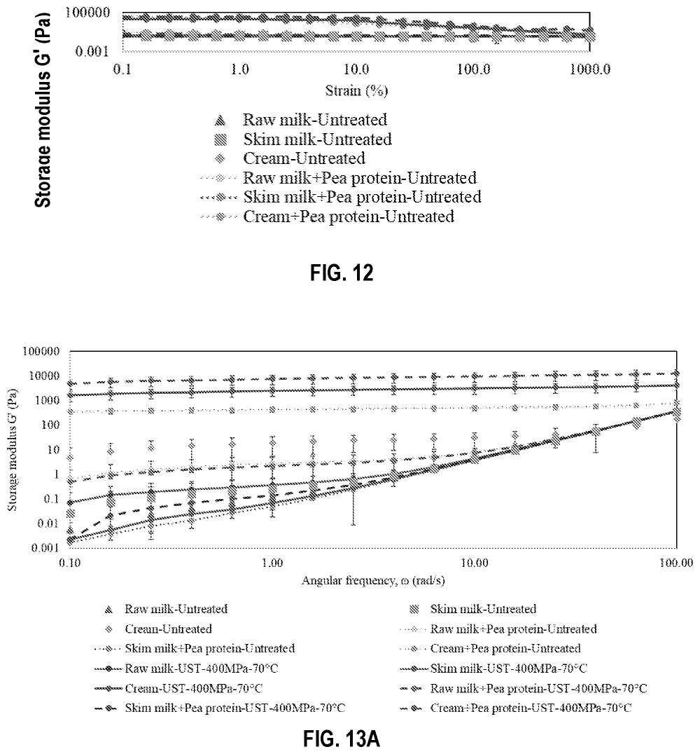

Strain sweep. The storage modulus (G′) as function of strain for different samples is shown in FIG. 12. All the untreated and UST treated samples with low fat content (skim milk, raw milk, skim milk+pea protein and raw milk+pea protein samples) showed a linear relationship with strain. UST treated cream and cream+pea protein samples, showed higher G′ than other samples, indicating the higher gel strength of these samples. Further, the trend showed two distinct regions (FIG. 12). After a strain of 10%, the storage modulus of these sample decreased with increasing strain, indicating a transition to viscoelastic liquid from a viscoelastic solid region.

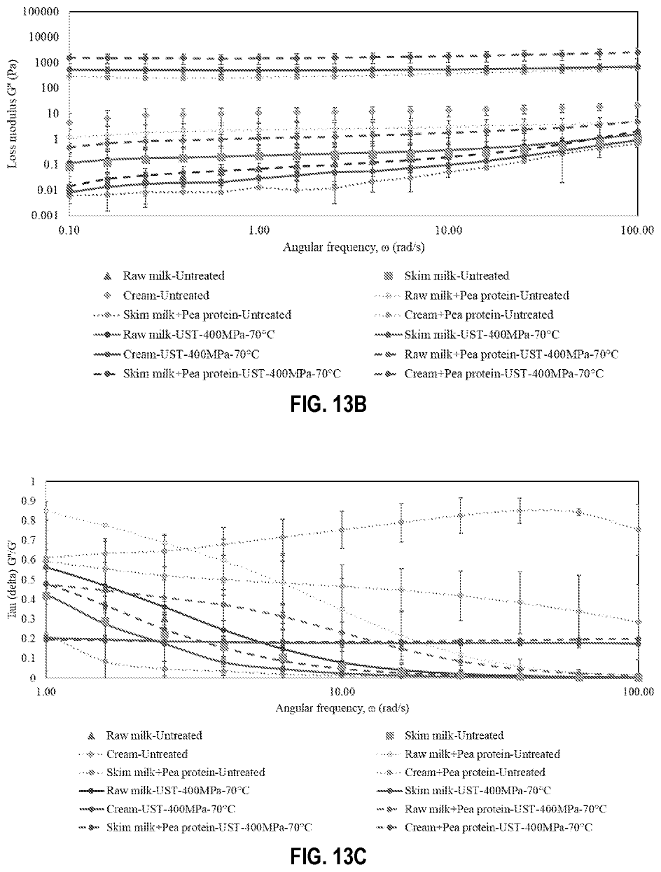

The rheological characteristics namely storage modulus (G′), loss modulus (G″) and tangent of phase angle (tan δ) with respect to angular frequency is shown in FIG. 13a-c.

The G′ and G″ values of both untreated and UST treated low fat samples namely, raw milk, skim milk with and without inclusion of pea protein were initially low and increased with frequency. This shows that the low fat samples in the study, especially skim milk, raw milk with added plant protein treated by UST could potentially serve as plant-animal protein blended milk, sauces. The G′ and G″ of untreated and UST treated high fat samples viz., cream, cream+pea protein were higher than the low fat samples indicating the role of fat content in increasing the gel strength. For these samples, the addition of pea protein appeared to increase the gel strength, as evidenced by the higher G′ of untreated cream+pea protein samples than untreated cream samples (FIG. 13a). The G′ of 70° C. UST treated high fat samples viz., cream, cream+pea protein samples were higher than untreated samples, which indicate the role of UST in creating stronger gel network in samples (FIG. 13a,b). Further, the G′ and G″ values of UST treated high fat samples appeared to be independent of frequency, which demonstrated the textural strength of these samples.

The intense mechanical forces such as pressure, shear and/or temperature during UST treatment induce denaturation/aggregation of globular proteins such as whey proteins (Dumay et al., 2013) and soy proteins (Floury et al., 2002). It has been reported that at gel-like formation in soy milk homogenized at pressures above 200 MPa might be attributed to disulfide bonding and non-covalent bonds such as hydrophobic interaction, ionic and hydrogen bonding (Utsumi et al., 1997). Thus, the effect of pressure, temperature and shear during UST on the milk and pea proteins could be responsible for the gel network in blends.

The change of loss factor i.e. tangent of phase angle (tan δ) as a function of angular frequency is presented in FIG. 13c. The tan δ values of all the samples were less than unity, indicating predominance of elastic behavior. For the low fat samples, both untreated and UST treated, the tan S decreased with increasing frequency, indicating increase in elastic behavior (Xiu et al., 2011). For untreated high fat samples, viz., cream and cream+pea protein samples, the tan δ appeared to increase with frequency initially followed by an eventual decrease (FIG. 13c). This can be attributed to the change of phase in cream emulsion. At low frequency, the fat globules in the untreated cream are broken down. With increasing frequency, the fat globules coagulate to form butter grains. Subsequently, the water in the emulsion is expelled, resulting in two fractions—butter and butter milk. This results in decrease in tan δ at higher frequencies. The pea protein in cream+pea protein samples could be entrapped in the butter or buttermilk portion.

On the other hand, for UST treated cream or cream+pea samples, the tan δ was almost constant and independent of frequency for a longer range (FIG. 13c). This indicated the ability of UST to facilitate higher gel strength in high fat samples by enabling macromolecular network. Thus, the structural stability of the samples treated by UST were evident.

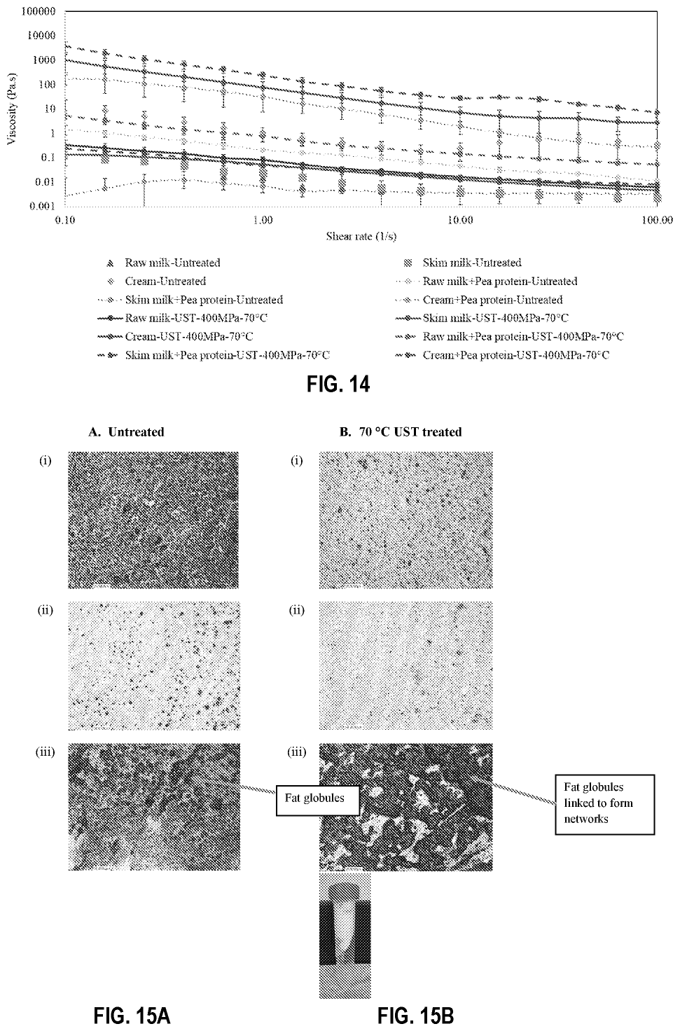

Flow sweep. The viscosities of samples at shear rates of 0.1-100 s⁻¹ is shown in FIG. 14. The viscosities increased with inclusion of pea protein and with increasing fat content. Further, the UST treatment increased the viscosities of the samples apparently for cream and cream+pea protein samples. The high pressure associated shear and temperature during UST treatment could have created collision of fat-fat and fat-protein particles resulting in particle interactions and molecular entanglements which increased the viscosity. Further, the UST process temperature could have caused partial denaturation of proteins in samples since the whey proteins milk and pea proteins have initial denaturation temperatures ˜70° C. (Lee, 1992; Mession et al., 2013). The protein denaturation could lead to increased viscosity. Increase in milk viscosity due to aggregates formed due to heat processing of whey protein denaturation has been reported by Li et al. (2018). For cream and cream+pea samples, the viscosity appeared to increase at shear rates over ˜6 s⁻¹. This could be attributed to the conversion of cream to butter grains in high shear rates.

Comparison of Viscoelastic Properties to Other Product Formulations

The G′ of cream+pea protein samples treated by UST ranged from 8784 to 14,034 Pa and this was close to the G′ of 15,279±417 Pa reported for bovine milk soft ripened cheese prepared using acetic acid (Mbye et al., 2020). In addition, the UST treated cream+pea samples had viscosity varying from 28 to 3859 Pa·s which is close to 1849±87 Pa·s reported for bovine milk soft ripened cheese (Mbye et al., 2020). Similarly, Sołowiej et al. (2014) analyzed the rheological properties of processed cheese analogues prepared using or acid casein or rennet casein only and in combination, with different proportions of whey protein concentrate or isolate. The viscosities of all the cheese analogues prepared varied between ˜3000 to 12000 Pa·s. These findings show the potential of UST treatment to prepare cheese or cheese analogues from dairy-plant protein blends.

Kantekin-Erdogan et al. (2019) used different combinations of monoglycerides, diglycerides and triglycerides as emulsifiers in preparation of mayonnaise. The initial viscosities of all samples decreased at the end of viscosity measurement due to the non-newtonian fluid structure of mayonnaise. With increasing shear rate from 0 to 10 s⁻¹, the viscosities decreased from ˜1000 to ˜2 Pa·s, which was close to the viscosities observed for cream and cream+pea samples treated by UST in the present study (FIG. 41). This demonstrates the ability of UST to create mayonnaise-like products using plant-animal protein blends.

Adapa et al. (2000) investigated the rheological properties of ice cream mixes prepared using different fat percentages ranging from 6 to 12%. For the ice cream mix with 12% milk fat, the G′ and G″ at 1 Hz (6.28 rad/s) frequency were reported as 2.23±0.61 Pa and 2.11±0.38 Pa respectively. In the present study, the G′ and G″ values at similar frequency (6.31 rad/s) were 1.71±0.19 Pa and 0.153±0.06 Pa respectively for UST treated skim milk+pea protein samples with milk fat of ˜0.5%. Likewise, the G′ and G″ values at similar frequency were 4.91±0.82 Pa and 1.56±0.59 Pa respectively for UST treated raw milk+pea protein samples with milk fat of ˜4.3%. The viscoelastic properties of skim milk+pea protein and raw milk+pea protein blends treated by UST were close to the ice cream mix with apparently high fat content. This indicate the ability of UST treatment to create plant-animal protein based ice cream mix type products with lesser fat content albeit with viscoelastic properties similar to high fat mixes.

The representative image showing the higher consistency of cream sample treated by UST is shown in FIG. 15B(iii). This demonstrated the role of pressure associated shear in UST to create interactions of fat and protein molecules. Further, the processing conditions involving combination of high pressure, temperature, and shear cause unfolding of proteins which lead to increased water binding capacity and swelling of proteins. This highlight the ability of the UST to modify the rheological properties of samples depending on fat content and the role of protein.

3.3. Microstructure and Particle Size

Microstructure

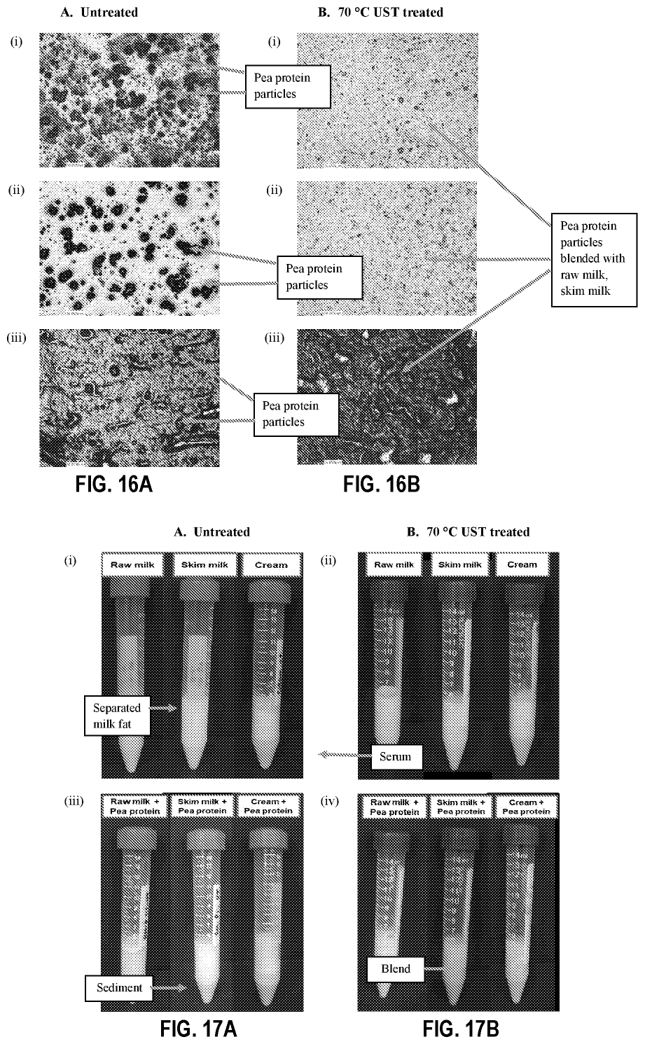

The microstructures of dairy suspensions of different fat content and the effect of UST treatment on the microstructures is presented in FIGS. 15 and 16. In FIG. 15A (i), (ii) and (iii) showing raw milk, skim milk and cream respectively, the large black particles represent fat globules, and apparently the particles are placed increasingly denser with increasing fat content in the suspension. Comparison of FIG. 15A, B-(i) &(ii) reveal that the 70° C. UST treatment clearly reduced the particle sizes and created homogenous suspension. During UST treatment, the suspensions under high pressure enter a tiny nozzle in shear valve which provides sudden depressurization. The passage of larger particles through the tiny gap in the shear valve causes reduction of particle size through physical rupture. Additionally, the instant pressure drop generates several physical forces such as shear, turbulence, cavitation etc. which create particle collisions and lead to particle size reduction when the internal resistance or strength of the particle is insufficient to sustain these forces. In low fat suspensions in the present study, UST treatment facilitated particle size reduction. In contrast, from FIGS. 15A&B-(iii), it can be observed that the 70° C. UST treatment appeared to increase the particle size. This might be because, the UST created small particles of fat globules which, under dense placement and rapid collision promoted by high pressure and shear action, aggregated and linked together to form networks of fat. Interestingly, comparison of FIGS. 15A and B-(iii) reveal that after UST treatment, the cream serum (i.e. liquid left after removal of fat globules from cream) is entrapped in the fat networks. The oil-in-water type emulsion in untreated cream might be converted to water-in-oil type emulsion due to UST treatment. The high pressure-shear application might break the milk fat globules and cause liquid fat to squeeze out of the fat globules (Rønholt et al., 2013). The fat globules create networks with other fat and protein molecules due to UST treatment and the networks entrap the serum portion. This effect also resulted in increased viscosity of these samples, as discussed in section 3.2. The increased viscosity also indicated presence of more solid fat content (SFC) in UST treated cream since a milk fat-based product is fully liquid without SFC and appears hard with increasing SFC (Narine & Marangoni, 1999).

In FIG. 16A (i), (ii) and (iii) showing raw milk+pea protein, skim milk+pea protein and cream+pea protein respectively, the large black almost circular-shaped pea protein particles can be seen suspended in the milk matrices. From FIG. 16A-B, (i)&(ii), it can be observed that the UST treatment reduced the milk, pea particle sizes and made the blend homogenous. From FIG. 16A-B (iii), it can be observed that the UST treatment created homogenous cream+pea protein blends by facilitating dispersion of pea protein in the fat globules in cream. Similar to UST treated cream samples, the cream+pea protein samples treated by UST showed visible linkages of protein and fat resulting in larger particle size. The high pressure, shear and temperature led to particle size modification and promoted molecular interactions between pea protein, milk protein and milk fat which led to homogenous plant-animal protein blends. The dense and homogenous blends of UST treated cream+pea blends (FIG. 16B-iii) also corroborate the higher viscosity and consistency index observed for these samples.

Particle Size

The particle size parameters viz., mean diameter and average height of the particles are shown in Table 4. The interaction of fat content and UST treatment had significant effect on the mean diameter and average height of the particles. The mean diameter of suspensions with inclusion of pea protein was significantly higher (p<0.05) than suspensions without pea protein. The mean diameter of UST treated blends were significantly different (p<0.05) than untreated samples. For low fat samples i.e. raw milk and skim milk without and with pea protein, the UST treatment reduced the mean diameter of the samples. The data corroborates the observation of LSM images of microstructures discussed in earlier section. Several studies have reported reduction of particle size by pressure associated shear treatment (Floury et al., 2004; Cortés-Muñoz et al., 2009; Song et al., 2013; Janahar et al., 2021). The particle size reduction could increase the number of particles and increase the probability of particle-particle interactions during application of pressure associated shear (Dumay et al., 2013).

In contrast, for high fat samples i.e. cream, without and with pea protein, the UST treatment increased the mean diameter (Table 4). The average height of UST treated cream and cream+pea protein samples were significantly higher (p<0.05) than other samples. UST could reduce the particle size of fat globules, proteins and facilitate interconnection between fat globules of smaller size, casein neo-micelles, whey protein aggregates and pea proteins and create a colloidal matrix with increased particle size. This could also be responsible for improved gel firmness (Dumay et al., 2013).

3.4. pH and Zeta Potential

The pH and zeta potential of samples are given in Table 4. The interaction of UST treatment and fat content did not have significant influence on the pH of the samples. The pH of samples of different fat content were treated by UST were not significantly different from untreated samples, in accordance with earlier research (Pereda et al., 2007; Janahar et al., 2021). pH contributes to modification of dissociation or association between protein subunits and so the adsorption of pea protein at the fat-water interface is dependent on pH (Gharsallaoui et al., 2009). Thus, the change in the rheological properties of UST treated suspensions with pea proteins could not be attributed to change in pH. Further, milk pH could indicate the production of lactic acid by microbes. No change in pH indicate that the gel formation in UST treated high-fat samples was not due to coagulation of milk proteins caused by lactic acid production.

The zeta potential indicates the magnitude of charge on a colloidal particle. The UST treatment, fat content and the interactions had significant effect on zeta potential. For all samples, the zeta potential reduced after UST treatment (Table 4). The pressure associated shear action in UST treatment could cause surface modifications in proteins and make the charged amino acid residues of protein move from surface to interior or create protein-protein linkage, thereby masking negative charges (Relkin & Shukat, 2012; Janahar et al., 2021). Wang et al. (2011) reported reduction of zeta potential of flax seed gum solutions when processed at homogenization pressures above 10 MPa. The authors attributed decrease of molecule chain size of flaxseed gum caused by HPH at pressures higher than 10 MPa to be responsible for reduction in zeta potential. Short chains could be easily involved in chemical reaction than the long chain (Wang et al., 2011). The reduction in zeta potential showed the effect of UST in changing structural characteristics based on composition of the plant-dairy protein blends.

3.5. Stability

The stability of the plant-animal protein blends treated by UST against creaming or particle sedimentation was determined by separation acceleration by centrifugation and visual observation of the different fractions of separated milk fat, sediment, serum and blend. The representative macroscopic analysis of different fractions in the samples is shown in FIG. 17.

3.5.1. Emulsion Stability

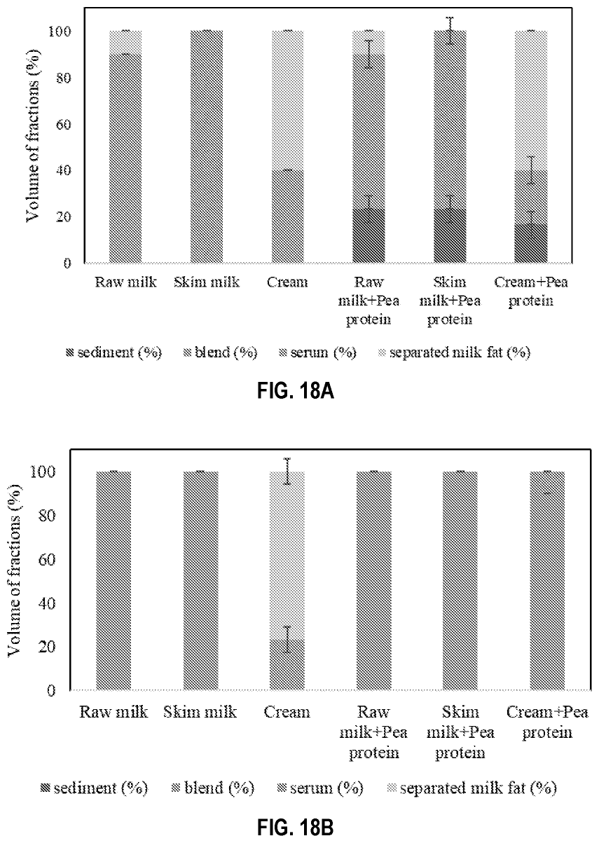

The volumes of different fractions separated after centrifugation of samples is shown in FIG. 18. In general, higher amount of separated milk fat and pea protein content can be indicators of lower stability. After centrifugation, the untreated raw milk and cream samples showed separated milk fat on top due to the natural phenomenon of clustering and rising of fat globules. Furthermore, all the untreated samples with added pea protein showed clear sedimentation of pea proteins at bottom, thereby showing the inability of milk matrix to self-stabilize by keeping the pea proteins suspended in solutions. All the UST treated samples were free from sediments and creaming phenomena. This demonstrated the ability of UST to create dairy-plant protein blended emulsion and keep it stable during refrigerated storage. In low fat samples i.e. raw milk, skim milk, raw milk+pea protein and skim milk+pea protein samples, the stability could be mainly contributed by reduction of particle size and in high fat samples, the stability could be contributed by the high viscosity of the samples, in accordance with Stoke's law. Interestingly, the serum volume in untreated cream samples is significantly (p<0.05) higher than UST treated samples. The effect on UST in creating fat and protein networks to entrap more serum and increase the volume of fat mass is thus realized. This explains the capability of UST to facilitate emulsion phase change in cream from oil-in-water to water-in-oil. Similarly, the volume of serum in untreated cream+pea protein were significantly (p<0.05) higher than UST treated cream+pea protein samples, which indicated higher water binding capacity.

3.5.2. Heat Stability

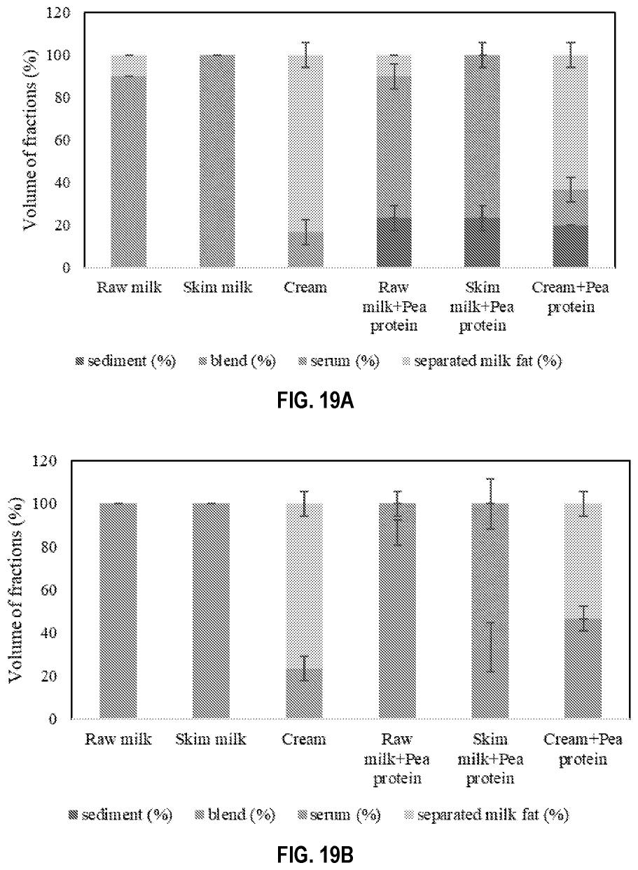

The volumes of different fractions of samples after heat treatment was not significantly different from the samples before heat treatment. Thus, the UST treated samples were stable to heat treatment at the conditions tested. However, centrifugation of the samples after heat treatment led to separation of fractions (FIG. 19). For instance, the UST treated raw milk+pea protein and skim milk+pea protein blends showed separation of liquid serum from the blends. This could be due to the reduced water retention capacity of the blends caused by heat treatment. Lee (1992) reported that at temperatures >70° C., intermolecular disulfide bonds can form in the protein molecules and parts of the peptide chain could link with each other by hydrophobic interactions. Consequently, protein aggregation and precipitation could occur. The heat treatments could cause protein denaturation and modify the proteins three-dimensional structure and reduce water holding capacity (Womeni et al., 2012). Separation of fat from the blend by melting during heat treatment in UST treated cream+pea protein samples is worth noting (FIG. 19). Hence, though the UST treated samples appear stable immediately after heat treatment, eventual onset of separation of contents is expected.

3.5.3. Freeze-Thaw Stability

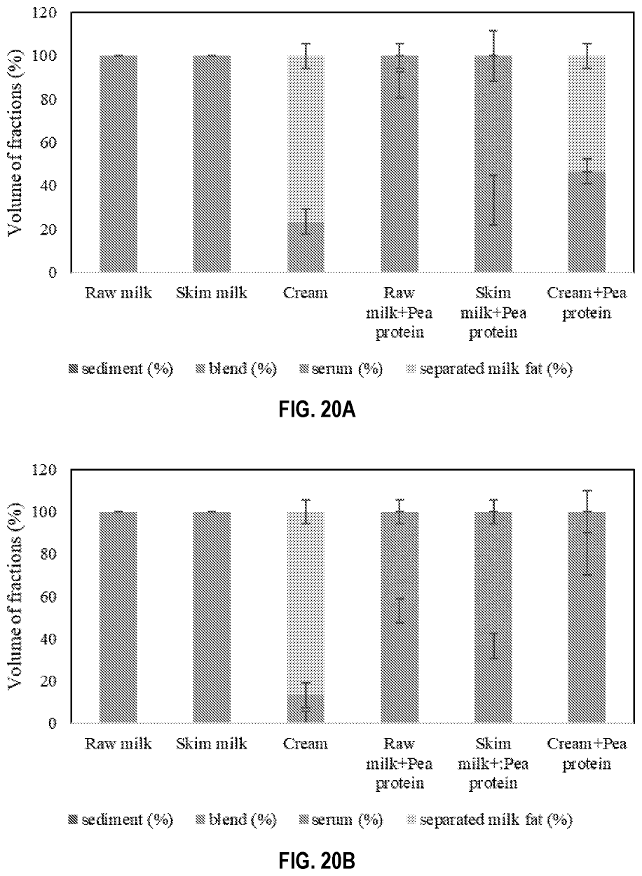

All 70° C. UST samples were stable after freeze-thaw treatment and showed no separation of contents. However, subsequent centrifugation of samples showed liquid serum separation in UST treated dairy-pea protein blended samples (FIG. 20). During freezing, the free water would be frozen leading to concentration of solids and reorganization of the molecules (Zheng & Sosulski, 1998). Subsequently, the ice crystals could cause disruption of cells resulting in release of entrapped water during thawing. This could have led to liquid serum separation in UST treated samples after freeze-thaw treatment and subsequent centrifugation.

4. Conclusion

The effect of ultra shear technology treatment at a high pressure of 400 MPa and process temperature of 70° C. on dairy protein sources and model dairy-pea protein suspensions with different fat contents were evaluated to understand the influence of varying fat content on the stability of UST treated animal-plant protein suspensions. By suitable combination of UST process parameter (pressure, temperature, shear) and ingredient composition (plant and animal protein and fat content), helped to realize products of wide range of characteristics. For example, in samples with low-fat content, the UST treatment reduced the particle size due to rupture of particles by high pressure associated shear action. On the other hand, high fat samples resulted in relatively larger particle sizes due to UST—induced molecular entanglements of fat and proteins. This was corroborated by increased viscosities and shear thinning behavior in high fat samples. All these can be accomplished without the need for any conventional synthetic emulsifier or preservatives. Thus, the versatile nature of UST technology enables the food processors to process animal-plant protein blends and formulations with different consistencies. Examples include dairy-plant protein based milk, spreads, cream or gel products, cream substitute, cheese type products, ice-cream formulations among others. The UST treated samples were stable upon centrifugation, with no sedimentation or creaming, demonstrating the suitability of UST to create stable emulsions. This finding would open ways to develop animal-plant protein based products and ingredients with limited or no use of additives to help stabilization in formulated foods, thereby enabling clean label ingredients and products.

The knowledge obtained in the present study will help understand the techno-functionality of plant-animal protein blends treated by UST, learn the flow behavior of the blends and design the UST process and equipment components for different products.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible aspects may be made of the invention without departing from the scope thereof, it is to be understood that all matter herein set forth or shown in the accompanying drawings is to be interpreted as illustrative and not in a limiting sense.

TABLE 1
Particle size parameters of samples

| S. | | Milk:Pea | Mean diameter | Average height |
|---|---|---|---|---|
| No. | Treatment | protein ratio | (μm) | (μm) |
| 1 | Untreated | 1:0.5 | 31.90^{a}* ± 2.46 | 87.36^{a} ± 25.64 |
| | | 1:1 | 35.58^{a} ± 1.37 | 78.18^{a} ± 16.41 |
| | | 1:3 | 37.89^{a} ± 7.31 | 58.34^{a} ± 7.72 |
| 2 | UST-400 MPa- | 1:0.5 | 2.48^{a} ± 0.05 | 8.54^{a} ± 0.68 |
| | 40° C. | 1:1 | 2.56^{a} ± 0.68 | 10.40^{a} ± 3.92 |
| | | 1:3 | 23.06^{b} ± 8.44 | 56.58^{a} ± 48.95 |
| 3 | UST-400 MPa- | 1:0.5 | 3.83^{a} ± 0.43 | 13.43^{a} ± 3.13 |
| | 70° C. | 1:1 | 4.63^{a} ± 1.41 | 20.15^{a, b} ± 6.91 |
| | | 1:3 | 44.10^{b} ± 13.08 | 29.98^{b} ± 5.79 |
| 4 | HPP-400 MPa- | 1:0.5 | 29.31^{a} ± 5.56 | 68.64^{a} ± 1.69 |
| | 25° C. | 1:1 | 30.05^{a} ± 2.51 | 89.59^{a} ± 16.09 |
| | | 1:3 | 27.41^{a} ± 4.01 | 67.48^{a} ± 11.47 |
| 5 | Thermal | 1:0.5 | 44.42^{a} ± 2.86 | 50.55^{a} ± 4.60 |
| | treatment-70° C.- | 1:1 | 36.38^{a} ± 4.57 | 80.74^{a}± 15.15 |
| | 0 min | 1:3 | 42.77^{a} ± 9.88 | 62.70^{a} ± 21.30 |
| 6 | Homogenization- | 1:0.5 | 10.79^{a} ± 2.54 | 100.21^{a} ± 4.01 |
| | 2000 psi-500 psi- | 1:1 | 11.15^{a} ± 5.91 | 66.51^{a, b} ± 31.16 |
| | 70° C. | 1:3 | 24.89^{b} ± 4.35 | 35.11^{b} ± 7.44 |

*Values are expressed as Mean ± Standard Deviation
**For each treatment, mean values without common superscripts in same column are significantly different (P < 0.05)

TABLE 2
Particle size parameters of untreated
milk:pea and water:pea samples

| S. | | Protein | Mean diameter | Average height |
|---|---|---|---|---|
| No. | Treatment | ratio | (μm) | (μm) |
| 1 | Untreated | 1:0.5 | 31.90^{a}* ± 2.46 | 87.36^{a} ± 25.64 |
| | Milk:Pea | 1:1 | 35.58^{a} ± 1.37 | 78.18^{a} ± 16.41 |
| | suspensions | 1:3 | 37.89^{a} ± 7.31 | 58.34^{a} ± 7.72 |
| 2 | Untreated | 0:0.5 | 31.39^{a} ± 3.63 | 45.75^{a} ± 42.97 |
| | Water:Pea | 0:1 | 36.79^{a} ± 0.60 | 35.30^{a} ± 4.00 |
| | suspensions | 0:3 | 41.30^{a} ± 6.40 | 45.09^{a} ± 3.13 |

*Values are expressed as Mean ± Standard Deviation
**The mean values without common superscripts in same column are significantly different (P < 0.05)

TABLE 3
Zeta potential, pH and solubility of samples

| S. | | Milk:Pea | Zeta Potential | | Protein solubility |
|---|---|---|---|---|---|
| No. | Treatment | protein ratio | (mV) | pH | (%) |
| 1 | Untreated | 1:0.5 | −44.72^{a}* ± 0.62 | 6.71^{a}**± 0.02 | 28.23^{a} ± 0.34 |
| | | 1:1 | −43.83^{a} ± 1.37 | 6.70^{a} ± 0.01 | 22.67^{b} ± 1.69 |
| | | 1:3 | −47.87^{b} ± 0.91 | 6.73^{a} ± 0.02 | 17.27^{c} ± 2.15 |
| 2 | UST-400 MPa- | 1:0.5 | −46.23^{a} ± 1.05 | 6.70^{a} ± 0.02 | 32.75^{a} ± 6.84 |
| | 40° C. | 1:1 | −37.78^{b} ± 0.40 | 6.71^{a} ± 0.03 | 20.17^{b} ± 0.70 |
| | | 1:3 | −29.16^{c} ± 1.13 | 6.71^{a} ± 0.03 | 28.36^{a, b} ± 1.08 |
| 3 | UST-400 MPa- | 1:0.5 | −46.70^{a} ± 0.50 | 6.67^{a} ± 0.04 | 31.28^{a} ± 1.85 |
| | 70° C. | 1:1 | −37.31^{b} ± 0.20 | 6.730^{a} ± 0.01 | 32.68^{a, b} ± 0.40 |
| | | 1:3 | −34.32^{c} ± 0.17 | 6.73^{a} ± 0.02 | 34.47^{c} ± 0.02 |
| 4 | HPP-400 MPa- | 1:0.5 | −45.30^{b} ± 0.48 | 6.82^{a} ± 0.01 | 31.72^{a} ± 4.55 |
| | 25° C. | 1:1 | −45.97^{b} ± 0.64 | 6.84^{a} ± 0.01 | 21.56^{a} ± 5.66 |
| | | 1:3 | −51.07^{a} ± 0.80 | 6.83^{a} ± 0.02 | 28.03^{a} ± 1.93 |
| 5 | Thermal | 1:0.5 | −51.23^{b} ± 0.71 | 6.68^{a} ± 0.02 | 25.24^{a} ± 6.88 |
| | treatment-70° C.- | 1:1 | −55.21^{a} ± 1.29 | 6.69^{a} ± 0.01 | 27.04^{a} ± 7.92 |
| | 0 min | 1:3 | −56.90^{a} ± 1.23 | 6.77^{b} ± 0.03 | 24.89^{a} ± 14.40 |
| 6 | Homogenization- | 1:0.5 | −44.41^{a} ± 1.21 | 6.73^{a} ± 0.01 | 17.27^{a} ± 1.50 |
| | 2000 psi-500 psi- | 1:1 | −40.71^{b} ± 0.79 | 6.74^{a} ± 0.01 | 18.23^{a} ± 6.54 |
| | 70° C. | 1:3 | −37.66^{c} ± 0.64 | 6.79^{b} ± 0.02 | 16.51^{a} ± 4.69 |

*Values are expressed as Mean ± Standard Deviation
**For each treatment, mean values without common superscripts in same column are significantly different (P < 0.05)

TABLE 4
Particle size parameters, pH, and zeta potential of samples

| | | Mean diameter | Average height | | Zeta potential |
|---|---|---|---|---|---|
| Treatment | Sample | (μm) | (μm) | pH | (mV) |
| Untreated | Raw milk | 4.69^{a} ± 2.91* | 42.15^{b}** ± 7.34 | 6.70^{a} ± 0.05 | −53.66^{a, b} ± 0.68 |
| | Skim milk | 4.93^{a} ± 4.10 | 14.79^{a} ± 4.49 | 6.73^{a} ± 0.03 | −54.63^{a, b} ± 1.50 |
| | Cream | 20.11^{a, b} ± 14.86 | 47.45^{b} ± 7.29 | 6.76^{a} ± 0.02 | −54.95^{a, b} ± 6.17 |
| | Raw milk + | 43.29^{b, c} ± 13.18 | 63.70^{b, c} ± 12.51 | 6.74^{a} ± 0.03 | −54.68^{a, b} ± 1.71 |
| | Pea protein | | | | |
| | Skim milk + | 44.20^{b, c} ± 15.35 | 86.86^{c} ± 7.17 | 6.74^{a} ± 0.01 | −49.17^{b} ± 4.99 |
| | Pea protein | | | | |
| | Cream + | 55.62^{c} ± 12.50 | 78.25^{c} ± 15.99 | 6.76^{a} ± 0.02 | −60.05^{a} ± 1.10 |
| | Pea protein | | | | |
| UST- | Raw milk | 2.77^{a} ± 1.92 | 16.66^{a} ± 3.03 | 6.73^{a} ± 0.03 | −35.92^{a} ± 0.36 |
| 400 MPa- | Skim milk | 2.46^{a} ± 1.89 | 15.29^{a} ± 1.64 | 6.77^{a} ± 0.03 | −36.03^{b, c} ± 1.00 |
| 70° C. | Cream | 44.80^{b} ± 6.56 | 49.97^{b} ± 8.45 | 6.78^{a} ± 0.03 | −45.20^{a} ± 3.81 |
| | Raw milk + | 7.55^{a} ± 0.70 | 18.97^{a} ± 4.79 | 6.74^{a} ± 0.03 | −37.56^{b, c} ± 0.83 |
| | Pea protein | | | | |
| | Skim milk + | 8.61^{a} ± 2.07 | 15.34^{a} ± 3.54 | 6.82^{a} ± 0.03 | −36.35^{b, c} ± 0.63 |
| | Pea protein | | | | |
| | Cream + | 79.08^{c} ± 5.75 | 63.38^{b} ± 20.99 | 6.80^{a} ± 0.04 | −40.69^{a, b} ± 1.02 |
| | Pea protein | | | | |

*Values are expressed as Mean ± Standard Deviation
**For each treatment, mean values without common superscripts in same column are significantly different (p ≤ 0.05)

### References from Example 1

Augusto, P. E., Ibarz, A., & Cristianini, M. (2012). Effect of high pressure homogenization (HPH) on the rheological properties of tomato juice: Time-dependent and steady-state shear. Journal of Food Engineering, 111(4), 570-579.
Bernat, N., Chafer, M., Rodriguez-Garcia, J., Chiralt, A., & González-Martínez, C. (2015). Effect of high pressure homogenisation and heat treatment on physical properties and stability of almond and hazelnut milks. LWT-Food Science and Technology, 62(1), 488-496.
Bonsegna, S., Bettini, S., Pagano, R., Zacheo, A., Vergaro, V., Giovinazzo, G., . . . & Santino, A. (2011). Plant oil bodies: novel carriers to deliver lipophilic molecules. Applied biochemistry and biotechnology, 163(6), 792-802.
Boye, J. I., Aksay, S., Roufik, S., Ribéreau, S., Mondor, M., Farnworth, E., & Rajamohamed, S. H. (2010). Comparison of the functional properties of pea, chickpea and lentil protein concentrates processed using ultrafiltration and isoelectric precipitation techniques. Food Research International, 43(2), 537-546.
Chen, X., Xu, X., & Zhou, G. (2016). Potential of high pressure homogenization to solubilize chicken breast myofibrillar proteins in water. Innovative Food Science & Emerging Technologies, 33, 170-179.
Choi, W. S., & Han, J. H. (2001). Physical and mechanical properties of pea-protein-based edible films. Journal of Food Science, 66(2), 319-322.
Devenyns, J. (2019). Live Real Farms taps into blended trend with the first dairy and plant-based milk. FoodDive. Accessed online: Nov. 10, 2020.
Dhakal, S., Giusti, M. M., & Balasubramaniam, V. M. (2016). Effect of high pressure processing on dispersive and aggregative properties of almond milk. Journal of the Science of Food and Agriculture, 96(11), 3821-3830.
Dickinson, E., & James, J. D. (1998). Rheology and flocculation of high-pressure-treated β-lactoglobulin-stabilized emulsions: comparison with thermal treatment. Journal of Agricultural and Food Chemistry, 46(7), 2565-2571.
Dumay, E., Lambert, C., Funtenberger, S., & Cheftel, J. C. (1996). Effects of high pressure on the physico-chemical characteristics of dairy creams and model oil/water emulsions. Lebensmittel-Wissenschaft+Technologie, 29(7), 606-625.
Funke, S., Matilainen, J., Nalenz, H., Bechtold-Peters, K., Mahler, H. C., & Friess, W. (2015). Analysis of thin baked-on silicone layers by FTIR and 3D-Laser scanning microscopy. European Journal of Pharmaceutics and Biopharmaceutics, 96, 304-313.
Gallier, S., Gordon, K. C., & Singh, H. (2012). Chemical and structural characterisation of almond oil bodies and bovine milk fat globules. Food Chemistry, 132(4), 1996-2006.
Gharsallaoui, A., Cases, E., Chambin, O., & Saurel, R. (2009). Interfacial and emulsifying characteristics of acid-treated pea protein. Food Biophysics, 4(4), 273-280.
Hesarinejad, M. A., Koocheki, A., & Razavi, S. M. A. (2014). Dynamic rheological properties of Lepidium perfoliatum seed gum: Effect of concentration, temperature and heating/cooling rate. Food Hydrocolloids, 35, 583-589.
Huppertz, T., Fox, P. F., & Kelly, A. L. (2003). High pressure-induced changes in the creaming properties of bovine milk. Innovative Food Science & Emerging Technologies, 4(4), 349-359.
Huppertz, T., Fox, P. F., & Kelly, A. L. (2018). The caseins: Structure, stability, and functionality. In Proteins in food processing (pp. 49-92). Woodhead Publishing.
Janahar, J. J., Marciniak, A., Balasubramaniam, V. M., Jimenez-Flores, R., & Ting, E. (2021). Effects of pressure, shear, temperature, and their interactions on selected milk quality attributes. Journal of Dairy Science, 104(2), 1531-1547.
Kubo, M. T. K., Augusto, P. E., & Cristianini, M. (2013). Effect of high pressure homogenization (HPH) on the physical stability of tomato juice. Food Research International, 51(1), 170-179.
Lan, Y., Xu, M., Ohm, J. B., Chen, B., & Rao, J. (2019). Solid dispersion-based spray-drying improves solubility and mitigates beany flavour of pea protein isolate. Food chemistry, 278, 665-673.
Lee, Y. H. (1992). Food-processing approaches to altering allergenic potential of milk-based formula. The Journal of pediatrics, 121(5), S47-S50.
Martínez-Monteagudo, S. I., Kamat, S., Patel, N., Konuklar, G., Rangavajla, N., & Balasubramaniam, V. M. (2017). Improvements in emulsion stability of dairy beverages treated by high pressure homogenization: A pilot-scale feasibility study. Journal of Food Engineering, 193, 42-52.
McClements, D. J., Newman, E., & McClements, I. F. (2019). Plant-based milks: A review of the science underpinning their design, fabrication, and performance. Comprehensive reviews in food science and food safety, 18(6), 2047-2067.
Meena, G. S., Singh, A. K., Borad, S., & Panjagari, N. R. (2016). Effect of concentration, homogenization and stabilizing salts on heat stability and rheological properties of cow skim milk ultrafiltered retentate. Journal of food science and technology, 53(11), 3960-3968.
Mession, J. L., Sok, N., Assifaoui, A., & Saurel, R. (2013). Thermal Denaturation of Pea Globulins (Pisum sativum L.). Molecular Interactions Leading to Heat-Induced Protein Aggregation. Journal of agricultural and food chemistry, 61(6), 1196-1204.
Moll, P., Salminen, H., Schmitt, C., & Weiss, J. (2021). Impact of microfluidization on colloidal properties of insoluble pea protein fractions. European Food Research and Technology, 247(3), 545-554.
Nichols, D. J., & Cheryan, M. (1982). Dairy and vegetable protein blends by co-extraction and co-ultrafiltration. Journal of Food Science, 47(2), 486-490.
Nosworthy, M. G., Tulbek, M. C., & House, J. D. (2017). Does the concentration, isolation, or deflavoring of pea, lentil, and faba bean protein alter protein quality?. Cereal Foods World, 62(4), 139-142.
NotCo (2019). NotCo adhoc online research, USA November, 2019. Accessed online: Nov. 10, 2020
Osen, R., Toelstede, S., Wild, F., Eisner, P., & Schweiggert-Weisz, U. (2014). High moisture extrusion cooking of pea protein isolates: Raw material characteristics, extruder responses, and texture properties. Journal of Food Engineering, 127, 67-74.
Pereda, J., Ferragut, V., Quevedo, J. M., Guamis, B., & Trujillo, A. J. (2007). Effects of ultra-high pressure homogenization on microbial and physicochemical shelf life of milk. Journal of dairy science, 90(3), 1081-1093.
Rasanayagam, V., Balasubramaniam, V. M., Ting, E., Sizer, C. E., Bush, C., & Anderson, C. (2003). Compression heating of selected fatty food materials during high-pressure processing. Journal of Food Science, 68(1), 254-259.
Relkin, P., & Shukat, R. (2012). Food protein aggregates as vitamin-matrix carriers: Impact of processing conditions. Food chemistry, 134(4), 2141-2148.
Schmidt, K. A., & Smith, D. E. (1988). Effects of homogenization on sensory characteristics of vanilla ice cream. Journal of Dairy Science, 71(1), 46-51.
Sejersen, M. T., Salomonsen, T., Ipsen, R., Clark, R., Rolin, C., & Engelsen, S. B. (2007). Zeta potential of pectin-stabilised casein aggregates in acidified milk drinks. International Dairy Journal, 17(4), 302-307.
Sethi, S., Tyagi, S. K., & Anurag, R. K. (2016). Plant-based milk alternatives an emerging segment of functional beverages: a review. Journal of food science and technology, 53(9), 3408-3423.
Shand, P. J., Ya, H., Pietrasik, Z., & Wanasundara, P. K. J. P. D. (2007). Physicochemical and textural properties of heat-induced pea protein isolate gels. Food Chemistry, 102(4), 1119-1130.
Sliwinski, E. L., Roubos, P. J., Zoet, F. D., Van Boekel, M. A. J. S., & Wouters, J. T. M. (2003). Effects of heat on physicochemical properties of whey protein-stabilised emulsions. Colloids and Surfaces B: Biointerfaces, 31(1-4), 231-242.
Smith, P. E., Krohn, R. I., Hermanson, G. T., Mallia, A. K., Gartner, F. H., Provenzano, M., . . . & Klenk, D. C. (1985). Measurement of protein using bicinchoninic acid. Analytical biochemistry, 150(1), 76-85.
Stratakos, A. C., Inguglia, E. S., Linton, M., Tollerton, J., Murphy, L., Corcionivoschi, N., . . . & Tiwari, B. K. (2019). Effect of high pressure processing on the safety, shelf life and quality of raw milk. Innovative Food Science & Emerging Technologies, 52, 325-333.
Sun, X. D., & Arntfield, S. D. (2010). Gelation properties of salt-extracted pea protein induced by heat treatment. Food Research International, 43(2), 509-515.
Tomé, A. S., Pires, C., Batista, I., Sousa, I., & Raymundo, A. (2015). Protein gels and emulsions from mixtures of Cape hake and pea proteins. Journal of the Science of Food and Agriculture, 95(2), 289-298.
Xiu, A., Zhou, M., Zhu, B., Wang, S., & Zhang, J. (2011). Rheological properties of Salecan as a new source of thickening agent. Food Hydrocolloids, 25(7), 1719-1725.
Ye, A., Anema, S. G., & Singh, H. (2004). High-pressure-induced interactions between milk fat globule membrane proteins and skim milk proteins in whole milk. Journal of dairy science, 87(12), 4013-4022.
Zhang, Z., Li, Y., Lee, M. C., Ravanfar, R., Padilla-Zakour, O. I., & Abbaspourrad, A. (2020). The impact of high-pressure processing on the structure and sensory properties of egg white-whey protein mixture at acidic conditions. Food and Bioprocess Technology, 13(2), 379-389.

### References from Example 2

Adapa, S., Dingeldein, H., Schmidt, K. A., & Herald, T. J. (2000). Rheological properties of ice cream mixes and frozen ice creams containing fat and fat replacers. Journal of dairy science, 83(10), 2224-2229.
Akhtar, M., Stenzel, J., Murray, B. S., & Dickinson, E. (2005). Factors affecting the perception of creaminess of oil-in-water emulsions. Food hydrocolloids, 19(3), 521-526.
Baier, D., Schmitt, C., & Knorr, D. (2015). Changes in functionality of whey protein and micellar casein after high pressure-low temperature treatments. Food Hydrocolloids, 44, 416-423.
Boukid, F., Rosell, C. M., & Castellari, M. (2021). Pea protein ingredients: A mainstream ingredient to (re) formulate innovative foods and beverages. Trends in Food Science & Technology, 110, 729-742.
Chojnicka-Paszun, A., De Jongh, H. H. J., & De Kruif, C. G. (2012). Sensory perception and lubrication properties of milk: Influence of fat content. International Dairy Journal, 26(1), 15-22.
Cortés-Muñoz, M., Chevalier-Lucia, D., & Dumay, E. (2009). Characteristics of submicron emulsions prepared by ultra-high pressure homogenisation: Effect of chilled or frozen storage. Food hydrocolloids, 23(3), 640-654.
Dumay, E., Chevalier-Lucia, D., Picart-Palmade, L., Benzaria, A., Gràcia-Julià, A., & Blayo, C. (2013). Technological aspects and potential applications of (ultra) high-pressure homogenisation. Trends in Food Science & Technology, 31(1), 13-26.
Floury, J., Desrumaux, A., & Legrand, J. (2002). Effect of ultra-high-pressure homogenization on structure and on rheological properties of soy protein-stabilized emulsions. Journal of food science, 67(9), 3388-3395.
Floury, J., Legrand, J., & Desrumaux, A. (2004). Analysis of a new type of high pressure homogeniser. Part B. study of droplet break-up and recoalescence phenomena. Chemical Engineering Science, 59(6), 1285-1294.
Gharsallaoui, A., Cases, E., Chambin, O., & Saurel, R. (2009). Interfacial and emulsifying characteristics of acid-treated pea protein. Food Biophysics, 4(4), 273-280.
Hayes, M. G., & Kelly, A. L. (2003). High pressure homogenisation of raw whole bovine milk (a) effects on fat globule size and other properties. Journal of Dairy Research, 70(3), 297-305.
Hayes, M. G., Fox, P. F., & Kelly, A. L. (2005). Potential applications of high pressure homogenisation in processing of liquid milk. Journal of Dairy Research, 72(1), 25-33.
Hinderink, E. B., Munch, K., Sagis, L., Schroën, K., & Berton-Carabin, C. C. (2019). Synergistic stabilisation of emulsions by blends of dairy and soluble pea proteins: Contribution of the interfacial composition. Food Hydrocolloids, 97, 105206.
Ho, K. K., Schroën, K., Martín-González, M. F., & Berton-Carabin, C. C. (2018). Synergistic and antagonistic effects of plant and dairy protein blends on the physicochemical stability of lycopene-loaded emulsions. Topics in Catalysis, 8(2), 175-187.
Janahar, J. J., Marciniak, A., Balasubramaniam, V. M., Jimenez-Flores, R., & Ting, E. (2021). Effects of pressure, shear, temperature, and their interactions on selected milk quality attributes. Journal of Dairy Science, 104(2), 1531-1547.
Ji, J., Zhang, J., Chen, J., Wang, Y., Dong, N., Hu, C., . . . & Wu, C. (2015). Preparation and stabilization of emulsions stabilized by mixed sodium caseinate and soy protein isolate. Food Hydrocolloids, 51, 156-165.
Kantekin-Erdogan, M. N., Ketenoglu, O., & Tekin, A. (2019). Effect of monoglyceride content on emulsion stability and rheology of mayonnaise. Journal of food science and technology, 56(1), 443-450.
Lam, A. C. Y., Can Karaca, A., Tyler, R. T., & Nickerson, M. T. (2018). Pea protein isolates: Structure, extraction, and functionality. Food Reviews International, 34(2), 126-147.
Lee, Y. H. (1992). Food-processing approaches to altering allergenic potential of milk-based formula. The Journal of pediatrics, 121(5), S47-S50.
Li, Y., Joyner, H. S., Carter, B. G., & Drake, M. A. (2018). Effects of fat content, pasteurization method, homogenization pressure, and storage time on the mechanical and sensory properties of bovine milk. Journal of dairy science, 101(4), 2941-2955.
Martínez-Monteagudo, S. I., Kamat, S., Patel, N., Konuklar, G., Rangavajla, N., & Balasubramaniam, V. M. (2017). Improvements in emulsion stability of dairy beverages treated by high pressure homogenization: A pilot-scale feasibility study. Journal of Food Engineering, 193, 42-52.
Mbye, M., Sobti, B., Al Nuami, M. K., Al Shamsi, Y., Al Khateri, L., Al Saedi, R., . . . & Kamal-Eldin, A. (2020). Physicochemical properties, sensory quality, and coagulation behavior of camel versus bovine milk soft unripened cheeses. NFS Journal, 20, 28-36.
McCarthy, K. S., Lopetcharat, K., & Drake, M. A. (2017). Milk fat threshold determination and the effect of milk fat content on consumer preference for fluid milk. Journal of dairy science, 100(3), 1702-1711.
Mession, J. L., Sok, N., Assifaoui, A., & Saurel, R. (2013). Thermal Denaturation of Pea Globulins (Pisum sativum L.). Molecular Interactions Leading to Heat-Induced Protein Aggregation. Journal of agricultural and food chemistry, 61(6), 1196-1204.
Narine, S. S., & Marangoni, A. G. (1999). Mechanical and structural model of fractal networks of fat crystals at low deformations. Physical Review E, 60(6), 6991.
Pereda, J., Ferragut, V., Quevedo, J. M., Guamis, B., & Trujillo, A. J. (2007). Effects of ultra-high pressure homogenization on microbial and physicochemical shelf life of milk. Journal of dairy science, 90(3), 1081-1093.
Rasanayagam, V., Balasubramaniam, V. M., Ting, E., Sizer, C. E., Bush, C., & Anderson, C. (2003). Compression heating of selected fatty food materials during high-pressure processing. Journal of Food Science, 68(1), 254-259.
Relkin, P., & Shukat, R. (2012). Food protein aggregates as vitamin-matrix carriers: Impact of processing conditions. Food chemistry, 134(4), 2141-2148.
Roach, A., & Harte, F. (2008). Disruption and sedimentation of casein micelles and casein micelle isolates under high-pressure homogenization. Innovative food science & emerging technologies, 9(1), 1-8.
Rønholt, S., Mortensen, K., & Knudsen, J. C. (2013). The effective factors on the structure of butter and other milk fat-based products. Comprehensive Reviews in Food Science and Food Safety, 12(5), 468-482.
Sołowiej, B., Cheung, I. W., & Li-Chan, E. C. (2014). Texture, rheology and meltability of processed cheese analogues prepared using rennet or acid casein with or without added whey proteins. International Dairy Journal, 37(2), 87-94.
Song, X., Zhou, C., Fu, F., Chen, Z., & Wu, Q. (2013). Effect of high-pressure homogenization on particle size and film properties of soy protein isolate. Industrial Crops and Products, 43, 538-544.
Thiebaud, M., Dumay, E., Picart, L., Guiraud, J. P., & Cheftel, J. C. (2003). High-pressure homogenisation of raw bovine milk. Effects on fat globule size distribution and microbial inactivation. International Dairy Journal, 13(6), 427-439.
Tunick, M. H., Ren, D. X., Van Hekken, D. L., Bonnaillie, L., Paul, M., Kwoczak, R., & Tomasula, P. M. (2016). Effect of heat and homogenization on in vitro digestion of milk. Journal of Dairy Science, 99(6), 4124-4139.
Utsumi, S. H. I. G. E. R. U., Matsumura, Y., & Mori, T. (2017). Structure-function relationships of soy proteins. In: Food proteins and their applications (pp. 257-292). CRC Press.
Wang, Y., Li, D., Wang, L. J., & Xue, J. (2011). Effects of high pressure homogenization on rheological properties of flaxseed gum. Carbohydrate polymers, 83(2), 489-494.
Womeni, H. M., Tiencheu, B., Linder, M., Nabayo, E. M. C., Tenyang, N., Mbiapo, F. T., . . . & Parmentier, M. (2012). Nutritional value and effect of cooking, drying and storage process on some functional properties of Rhynchophorus phoenicis. International Journal of Life science & Pharma Research, 2(203).
Xiu, A., Zhou, M., Zhu, B., Wang, S., & Zhang, J. (2011). Rheological properties of Salecan as a new source of thickening agent. Food Hydrocolloids, 25(7), 1719-1725.
Zamora, A., Ferragut, V., Guamis, B., & Trujillo, A. J. (2012). Changes in the surface protein of the fat globules during ultra-high pressure homogenisation and conventional treatments of milk. Food Hydrocolloids, 29(1), 135-143.
Zheng, G. H., & Sosulski, F. W. (1998). Determination of water separation from cooked starch and flour pastes after refrigeration and freeze-thaw. Journal of food science, 63(1), 134-139.

1. A method of using ultra sheer technology to form a homogenous product from a combination of a plant protein and an animal protein source, the method comprising:
a. combining a plant protein source and an animal protein source;
b. placing the plant protein source and animal protein source under conditions to form a homogenous product, wherein said conditions comprise
i. pressure varying from 2,000 psi to 87,000 psi; and
ii. temperature from 5-100° C.;
wherein shear enables blending of the animal and plant protein sources to form a homogeneous product.

2. The method of claim 1, wherein different proportions of plant and animal proteins can be used.

3. The method of claim 2, wherein the homogenous product can have varying viscosity depending on conditions and starting products.

4. The method of claim 1, wherein the plant protein source is selected from one or more of pea, chia, soy, mung bean, cashew, almond, peanut, and chia seeds.

5. The method of claim 1, wherein the animal protein source is selected from one or more of cow milk (2 to 3.5% fat), cream, whey, goat milk and butter milk.

6. The method of claim 1, wherein the animal protein to plant protein starting ratio can range from 1:0.5 to 1:1 to 0.5:1.0 by weight.

7. The method of claim 1, wherein different treatment combinations create beverages of different stability and viscosity.

8. The method of claim 1, wherein weight of the protein sources, different combinations of pressure, temperature and shear enable blending of different proportions of proteins of animal and plant sources to form homogeneous products with varying viscosity.

9. The method of claim 8, wherein shear exposure at pressure of 60,000 psi results in a product that is stable, with high viscosity.

10. The method of claim 1, wherein the strength of gel network of the product increases with temperature.

11. The method of claim 8 wherein at a combination of pressure of 2,000 psi, and temperature at 40-70° C., and shear, the product is stable and has relatively less viscosity.

12. A product produced from the method of claim 1.

13. The product of claim 12, wherein said product is a liquid beverage, a smoothie, or a protein shake.

14. The product of claim 12, wherein the product is a cream-type product, sauce-type product, gel-type product, or a solid or dehydrated type product, or a plant-dairy-based spread product, or a plant-dairy based egg substitute.

15. (canceled)

16. (canceled)

17. (canceled)

18. The product of claim 14, wherein the gel-type product is butter, jelly, or other gel-type product.

19. (canceled)

20. (canceled)

21. The product of claim 12, wherein no addition of synthetic binding agents to prevent separation of plant and animal protein components are required.

22. The product of claim 12, wherein no addition of synthetic stabilizing agents to keep the product stable are required.

23. The product of claim 12, wherein the product produced by the method is stable, with no sedimentation, for up to 5, 10, 15, 20, 25, 30, or more days under refrigeration.

24. The method of claim 1, wherein the animal protein comprises 0-40% fat content.

25. (canceled)

26. (canceled)

27. The method of claim 24, wherein consistency of blend of plant and animal protein can be modified based on fat concentration.

28. The method of claim 27, wherein the homogenous product has less than 1% fat separation.

29-60. (canceled)
